(19) United States
(12) Patent Application Publication
(10) Pub. No.: US 2011/0225000 A1
(43) Pub. Date: Sep. 15, 2011

(54) SYSTEM FOR MANAGEMENT AND REPORTING OF PATIENT DATA

(76) Inventor: Niazy Selim, Overland Park, KS (US)

(21) Appl. No.: 12/878,032

(22) Filed: Sep. 8, 2010

Related U.S. Application Data
(60) Provisional application No. 61/240,500, filed on Sep. 8, 2009.

(51) Int. Cl. G06Q 50/00; G06Q 10/00

(52) U.S. Cl. 705/2

(57) ABSTRACT

The present invention is directed to a system for improving medical provider transactions the system comprising a storage device adapted for retrievable storage of patient data via a computer system having at least one processor, a reporting and billing module in communication with the storage device for the retrieval of patient data, a forms repository having a plurality of electronically stored standardized forms with the patient data being populated into at least one standardized form associated with a medical event by the reporting and billing module.

### CROSS-REFERENCE TO RELATED APPLICATION

This application claims priority under 35 U.S.C. 119(e) and 37 C.F.R. 1.78(a)(4) based upon copending U.S. Provisional Application Ser. No. 61/240,500 for SYSTEM FOR MANAGEMENT AND REPORTING OF PATIENT DATA, filed Sep. 8, 2009, the disclosure of which is incorporated herein by reference.

### FIELD OF THE INVENTION

The present invention relates generally to the storage and accessibility of electronic patient information and more specifically to the input, storage, and reporting of patient information for a medical event to a medical provider and review of medical information by the patient.

### BACKGROUND OF THE INVENTION

Traditionally, providing health care has primarily involved the scientific knowledge of a medical provider. Recently however, medical payment providers have become more involved in the health care process and thus economic and procedural aspects of the treatment have become more important. Many health care providers are finding their practices more focused on the financial or billing aspects rather than the patient treatment aspects with many medical treatment decisions being managed by insurance providers rather them medical providers. For this reason, many patients are also now more involved in the health care process when the medical condition allows.

Prior to an examination or treatment by a medical provider, various forms and information must be gathered by the medical office to complete the patient intake process. Some of this information includes patient medical history, current treatments, medications, insurance and other pertinent information. Additional information may be available to the medical office including notes or prior patient visits, prior laboratory tests, prior diagnosis, prescribed medications and administered treatments. Unless this information is provided to the medical provider, it must be manually collected and recorded by the medical provider and stored in the patient file. In addition, the medical provider may need to supplement the information based upon referrals or diagnoses, medications or treatments administered. Unless this information is provided to the medical office, the medical office may need to collect this information either from the patient or medical provider, decreasing the evaluation time available to the medical provider. There exists a need to provide the patient information to the medical provider for the diagnosis and treatment of patients; therefore, there exists a need for readily sharing patient information with the medical provider and the medical office.

Sometimes, this information is redundant and often is redundant between different medical providers. Regardless of redundancy, the information may under certain conditions be necessary for treatment of the patient—for example medical providers may refuse to treat a patient unless or until appropriate patient medical history is obtained. In addition, reimbursement to a medical provider for a visit by a patient may be refused or downgraded depending on the completeness of the patient information record. Patients are routinely expected by medical payment providers and medical providers to perform what was once performed solely by medical providers. As medical payment providers and patients become more actively involved in the health care process, new technologies must support this evolving model of health care. Medical payment providers and patients expect a means to be able to meaningfully participate in the health care process. The prior art has assisted in the early stages of the evolving health care process by such means as allowing a patient to setup a medical event in an automated manner. The prior art has even assisted medical providers in diagnosing medical conditions of patients via such means as expert systems. Expert systems are disclosed in U.S. Pat. No. 5,517,405. However, the prior art is deficient in responding to the medical payment provider's increasing participation in the health care process.

Typically in dealing with a medical event, the medical provider is focused on applying medical knowledge to the patient's medical condition. While doing so, the medical provider may not know the external requirements of a given medical payment provider. In order to obtain such information, the medical provider frequently resorts to contacting a medical payment provider on a patient by patient basis to determine what information must be submitted and what policies must be complied with. This results in additional cost, staff, and lost time that could have been used aiding other patients. Because of this, it would be advantageous to provide a system which integrates the medical payment provider requirements into the health care process during all stages of the medical event.

The prior art is also deficient in providing a means for the patient to meaningfully participate in the health care process. In fact, some medical payments providers expect or compensate the medical provider for assisting the patient in following a medical treatment plan based on the medical provider's examination data. Moreover, patient needs may also make it necessary for patient participation. Because of this, it would be advantageous to provide a system that integrates patient participation into the medical event.

### SUMMARY OF THE INVENTION

The present invention is directed to a system for improving medical provider transactions said system comprising a storage device adapted for retrievable storage of patient data via a computer system having at least one processor, a reporting and billing module in communication with said storage device for the retrieval of patient data, a forms repository having a plurality of electronically stored standardized forms, and said patient data being populated into at least one standardized form associated with a medical event by said reporting and billing module.

### BRIEF DESCRIPTION OF THE DRAWINGS

FIG. 1 is a systematic block diagram of an embodiment of the invention.

FIG. 2 is a block diagram of an embodiment of the invention

FIG. 3 is a flow diagram of an embodiment associated with the Questionnaire Module in an embodiment of the invention.

FIG. 4 is a graphical interface screen in association with an embodiment of the invention.

FIG. 5 is a graphical interface screen in association with an embodiment of the invention.

FIG. 6 is a graphical interface screen in association with an embodiment of the invention.

FIG. 7 is a graphical interface screen in association with an embodiment of the invention.

FIG. 8 is a graphical interface screen in association with an embodiment of the invention.

FIG. 9 is a graphical interface screen in association with an embodiment of the invention.

FIG. 10 is a graphical interface screen in association with an embodiment of the invention.

FIG. 11 is a graphical interface screen in association with an embodiment of the invention.

FIG. 12 is a graphical interface screen in association with an embodiment of the invention.

FIG. 13 is a graphical interface screen in association with an embodiment of the invention.

FIG. 14 is a graphical interface screen in association with an embodiment of the invention.

FIG. 15 is a graphical interface screen in association with an embodiment of the invention.

FIG. 16 is a flow diagram of an embodiment associated with the Questionnaire Module in an embodiment of the invention.

FIG. 17 is a flow diagram of an embodiment associated with the Questionnaire Module in an embodiment of the invention.

FIG. 18 is a graphical interface screen in association with an embodiment of the invention.

FIG. 19 is a flow diagram of an embodiment associated with a Targeted Medical Condition in an embodiment of the invention.

FIG. 20 is a graphical interface screen in association with an embodiment of the invention.

FIG. 21 is a graphical interface screen in association with an embodiment of the invention.

FIG. 22 is a flow diagram of an embodiment associated with a Medical Professional Login in association with an embodiment of the invention.

FIG. 23 is a flow diagram associated with an Examination Module in association with an embodiment of the invention.

FIG. 24 is a graphical interface screen associated with an embodiment of the invention.

FIG. 25 is a graphical interface screen associated with an embodiment of the invention.

FIG. 26 is a graphical interface screen associated with an embodiment of the invention.

FIG. 27 is a flow diagram associated with a Diagnosis Module in association with an embodiment of the invention.

FIGS. 28-51 are a graphical interface screens associated with an embodiment of the invention.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

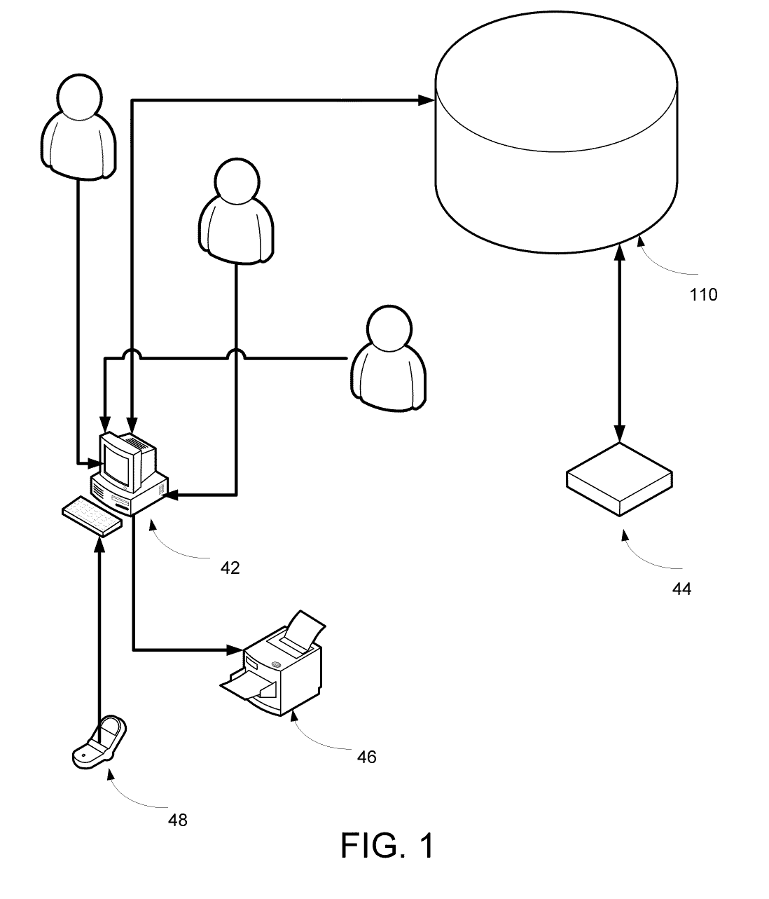

FIG. 1 depicts a block diagram of a medical reporting system generally referred to herein as reference numeral 110 in one embodiment of the invention. As illustrated in FIG. 1, a computer 42 may be used to access a mass storage device 44 which may retrievably store various system data such as Patient Information data, Medical Professional Information, notes, messages or alerts associated with the Patient. The computer 42 includes a processor, which is typically used with commercially available operating systems such as Microsoft, UNIX, or some other operating systems; the computer 42 including standard features such as internal memory, electronic storage device 44, video display card, keyboard or other standard peripheral input devices, output devices 46 such as a printer, and standard electronic circuitry.

The computer 42 may connect to an internal network through a standard network interface card or the computer 42 may connect to an external network or even through a global network like the internet using a secure interface protocol via a direct network connection such as a T1 line, T3 line, ISDN line or a wireless connection to communicate with other computers associated with the system 110.

Typically, the computer 42 will be located at the medical office; however, the computer 42 may be located offsite or it may be in communication with an offsite server located at a remote location for access by several medical offices or for access by the patient, medical professional or medical office to the offsite computer. If the system 110 is configured with an offsite server in communication with the local computer 42 located at the medical office, a portion or all of the system information may be replicated on a local storage device, like an internal or external hard drive, in communication with the server for storage and backup purposes.

In addition to standard peripheral devices such as a mouse, keyboard and printer, the computer 42 located at the medical office may include a barcode reader 48 for electronically reading printed barcodes associated with any received, stored or distributed documents, information or literature. The barcode reader 48 may be a handheld version, such as the commercially available Magellan® 1400i omni-directional handheld scanner, Magellan being a registered trademark of PSC, Inc.

The computer 42 may be located near a patient examination room or another convenient location, or the computer 42 may be located near a centrally located work station for access by multiple system users. To prevent unauthorized access the system 110 is configurable with a variety of security methods including password verification and user identifiers.

Additionally, the medical office or other administrative personnel may configure the system 110 based on the user and/or security policies to personalize the system for each user account with various limitations and authorizations to review, initiate or monitor features of the system 110.

User accounts may be configured with secured access, requiring the user to provide login credentials, or optionally use biometrics such as fingerprint, hand print or other user identifying credentials. For example, US Biometrics offers several USB fingerprint scanners, including The Q, which may be connected to a USB port on the computer.

The user accounts may also be configured so that only certain users are allowed to add or review Patient Information or edit the Patient Information; including limiting any changes to stored Patient Information to proper medical personnel with optional limits on the ability to generate various system reports. However, the above referenced system configurations may also vary for each medical office utilizing the system 110 and each user. In addition, the system 110 may provide for the generation of various patient interface screens, reports or other textual data in alternative or different languages. The medical office security policy may also be adjusted such that the system 110 is in compliance with such guidelines as HIPAA, federal or state medical guidelines or other medical personnel and medical office guidelines. Therefore, the above reference configurations are simply exemplary and as understood by those skilled in the art, the system 110 may provide for a number of different configurations by each medical office.

In addition, the system 110 allows for customization of various features as may be readily understood and described herein. The medical office may have the option to configure the system 110 with Medical Provider data associated with each medical provider and store it within the storage device 44. By configuring the system 110, user access may be limited to only those system features needed by the user.

The system 110 includes a server, depicted in FIG. 1 integrated with the computer 42, for storing patient data. The computer has a connection to the Internet in the preferred embodiment, which serves a global computer network for sharing information with other participating computers on the network. Illustrated in FIG. 1 is a computer 42 located at a medical office which is in communication through the internet and through a local network to various local computers for access by a medical provider who can receive patient data, review it, and store it within a retrievable storage device 44 connected to the server.

T0 permit access to the system by a patient, the medical office, medical personnel or another administrative user, the system 110, for example, may be configured with a combination patient id and/or password, or a user may create their own unique patient id and/or password to access the system 110 for entering and reviewing Patient Information. A patient id may be a social security number or some other unique identifier which the system 110 can associate with the Patient Information. In addition to password protection, other encryption methods may be utilized to protect and secure access.

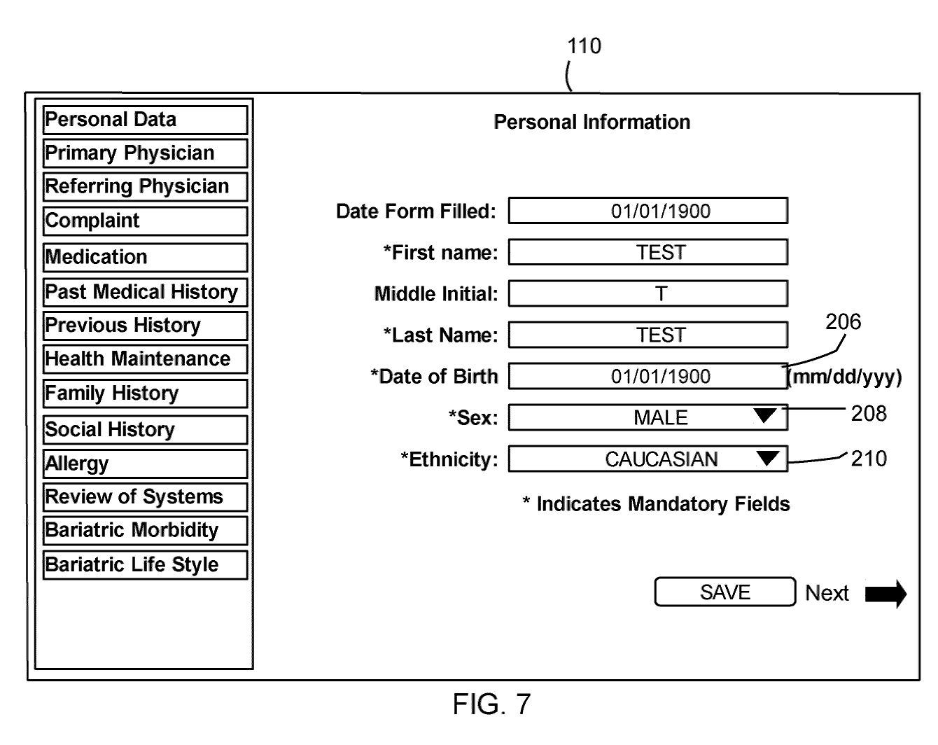

Preferably, the computer software is capable of universal application on computers used by multiple medical office facilities, on remote electronic devices associated with the patient, and is capable of use in communication with various input devices such as keyboards, selection and peripheral devices as well as output devices like printers and monitors for displaying various screens populated with electronic information such as a screen displaying a form selected from the Forms Repository 120 during entry of patient data 140. Patient Data may include patient name, patient address, patient medical information, family information, social information and life-style information. Additionally, the system 110 may include a number of features divided into modules including a Questionnaire Module 878, an Examination Module 880, a Diagnosis Module 882 and a Reports and Billing Module 884,886. By way of example, in the Questionnaire Module 878 patient information is collected using a number of Patient Information Screens (FIGS. 7-15) generated by the system and utilized by the patient. These screens may include a new patient survey questionnaire form, generated by the Form Repository 120.

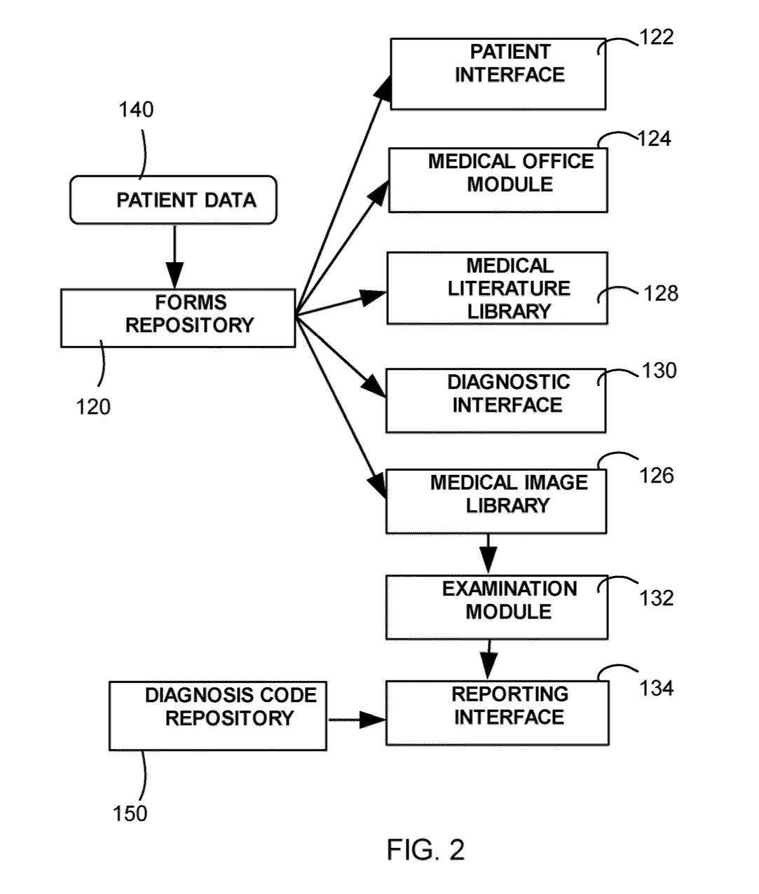

As illustrated in FIG. 2, a patient associated with a Patient ID provides Patient Data 140 through the internet or other method of electronic communication using the Forms Repository 120 provided by the system 110. Generally, the Forms Repository 120 includes a number of listings adapted to elicit responses and electronically receive patient information for retrievable storage by the system 110 in the form of Patient Data 140. The Patient Data 140 may include text and non-text data or a combination thereof which is transmitted via a computer and software through electronic communications for use with various system interfaces, modules and libraries.

Using a computer with a keyboard, mouse and the display monitor and connected to the Medical Office through the Internet, the patient may provide the requested information with a computer associated with the patient by way of a patient interface 122. The received Patient Information may then be associated with the patient record and retrievably stored by the system 110. As illustrated in FIG. 2, the retrievably stored Patient Data 140 is available for other features like the Medical Office Module 124, Medical Image Library 126, Medical Literature Library 128 and Diagnostic Interface 130 or the Examination Module 132.

The medical literature library 128 consists of medical condition statements that are associated with specific medical conditions. The medical literature library 128 is comprised of a database of medical literature indexed using a medical condition classification system. Preferably, the database is indexed using the International Classification of Diseases and Related Health Problems, Ninth Revision (ICD-9), which provides codes to classify medical conditions with a known variety of medical symptoms. Each known medical condition is assigned a unique category and given a unique number. Alternatively, different systems may be used as an index to the medical literature. These may include other ICD revisions, Systematized Nomenclature of Medicine of the College of American Pathologists (SNOMED), International Statistical Classification of Diseases and Related Health Problems of the World Health Organization (ISCD), and Current Procedural Terminology of the American Medical Association (CPTR™), classification systems used by specific medical payment providers, or proprietary classification systems.

The medical literature contained in the database is indexed using at least one medical condition classification system. The medical condition statements may include explanations of a medical condition, images of medical conditions, instructions on living with a medical condition, instructions on medical treatment plans, images of medical treatment plans, or other similar information. The information may come from public domain sources, articles, books, internet, medical payment providers, or other sources.

The medical literature is populated electronically, manually, or by a combination of the two methods. Physical sources, such as books or articles, may be converted to electronic formats and retrievably stored. Electronic information may be imported into the medical literature library or a pointer to it may be stored. Medical literature can be manually input via a scanner, keyboard, or other input devices. In addition to the content of the medical literature, an associated medical condition classification or other information may be stored to aid in the indexing of the medical literature. The form repository 120 may also provide for receipt of recorded verbal commands for data entry within various documents contained within the form repository including documents received from medical payment provider.

In FIG. 2, as further described below, the Reporting Interface 134 is in communication with a Diagnosis Code Repository 150 to provide approved diagnosis codes during the Reporting Interface 134. Approved diagnosis codes may be coordinated with various medically recognized diagnostic codes such as ICD-9-CM, ICD-10, ICPC-2, ICSD, NANDA, Diagnostic and Statistical Manual of Mental Disorders or DSM-IV, Mendelian Inheritance in Man and SNOMED.

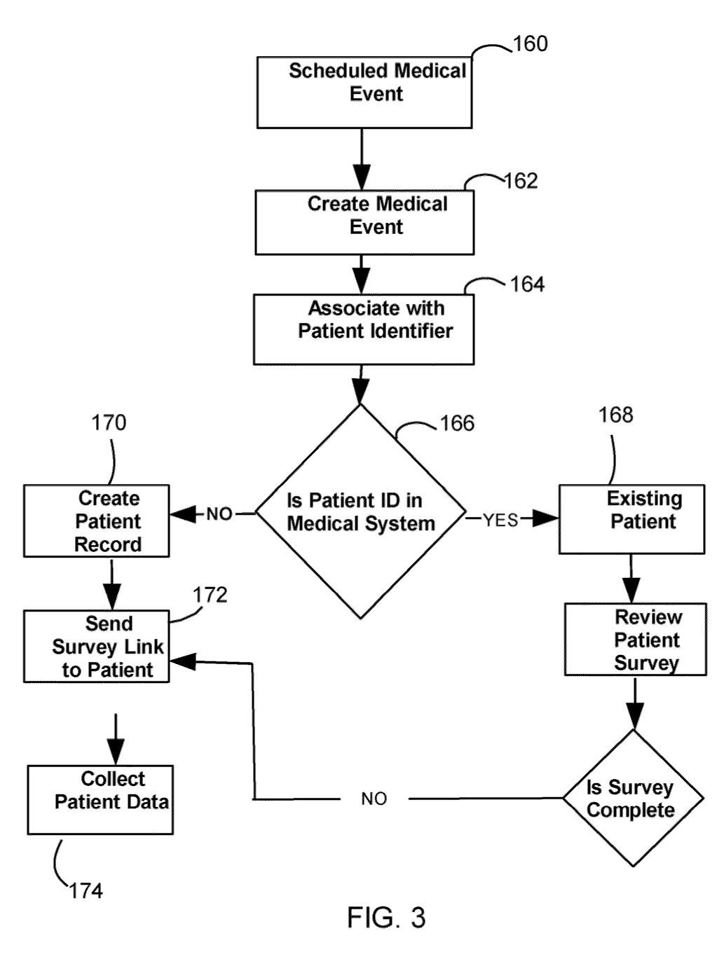

As illustrated in FIG. 3, once the patient has contacted the medical office to schedule 160 a medical event, the medical office creates 162 the medical event and associates a patient identifier 164 with the scheduled medical event 160. The patient identifier 164 may be a unique identifier provided by the patient, e.g. a social security number, or it may be a system generated identifier which is unique and is associated 164 with the patient. The system 110 then checks 166 to see if the patient identifier already exists. If the patient identifier 164 exists, it is associated with an existing patient 168. If the patient identifier 164 does not exist, the system creates a new patient record 170. When a new patient record is created 170, the system 110 sends a survey link to the patient 172. The survey is used to collect patient data 174.

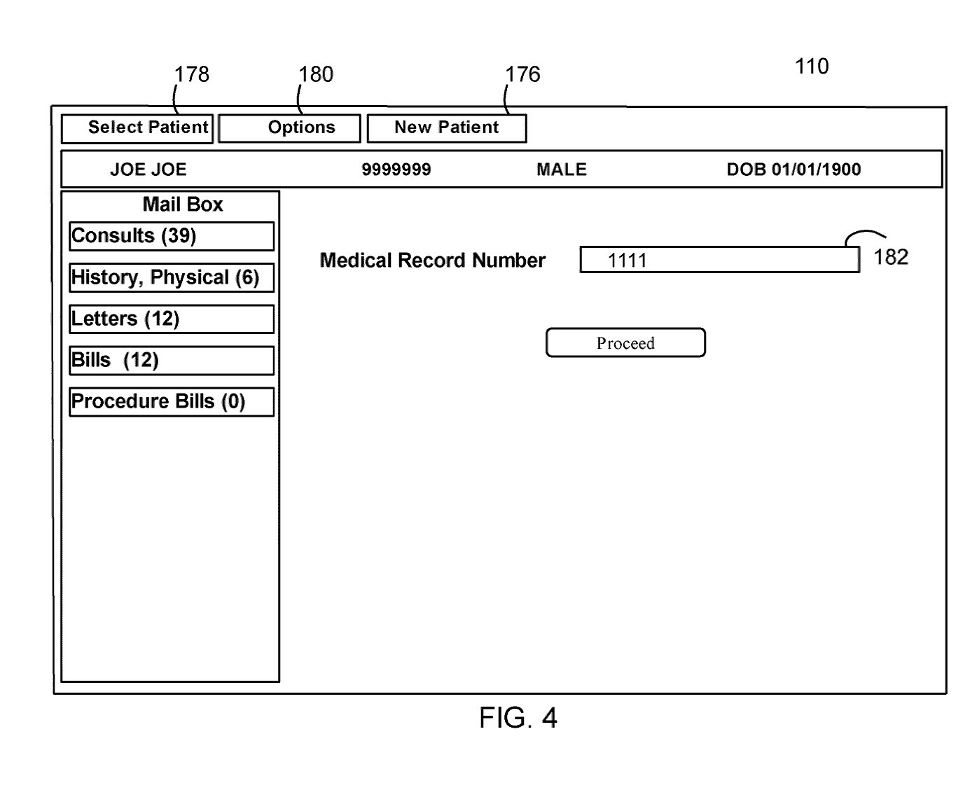

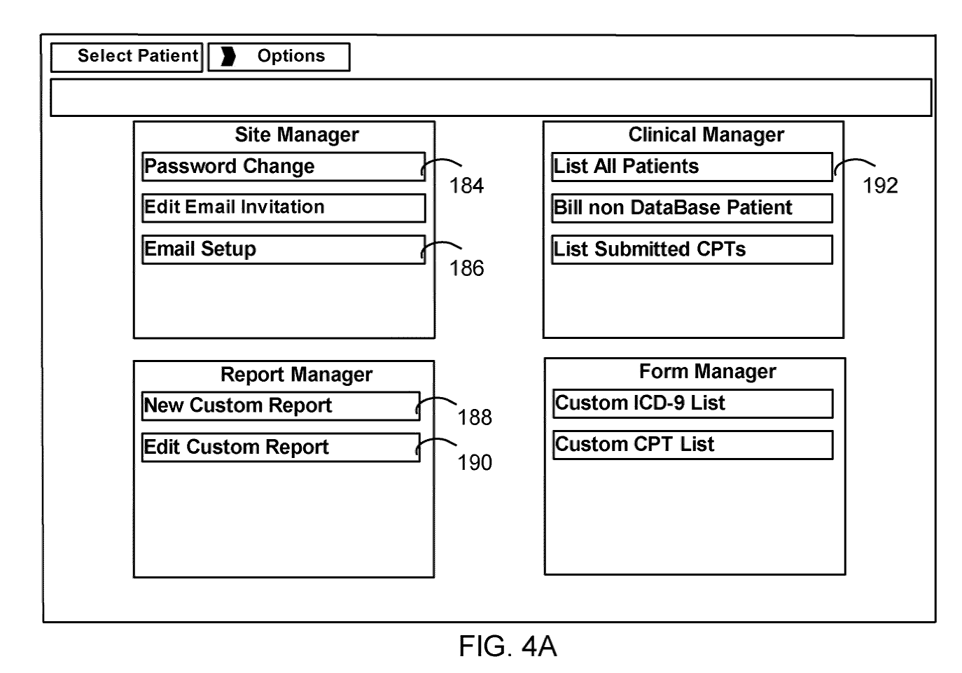

As generally indicated in FIG. 4, the patient identifier allows the patient to be enrolled into the system 110. FIG. 4 illustrates an example of an administrative screen in which a system user logs into the system 110 and can perform various administrative or back-office functions. From the illustrated screen the user can select a record containing Patient Information and associated with a patient 178, or they can create a New Patient record 176 or review or modify various system options 180. In selecting a patient, the user enters a medical record number 182 or at least a name which corresponds to a record containing Patient Information related to a patient examination or other medical event. In addition, the user can review other system information including consultations, system generated reports, historical correspondence, system generated invoices and other ongoing or historical information.

As illustrated in FIG. 4a, the system 110 provides a user the ability to modify various system options. A user may, among other things, have the option to modify the user's password 184, modify the way the user's email is setup 186, create a new custom report 188, edit an existing custom report 190 and list all patients 192.

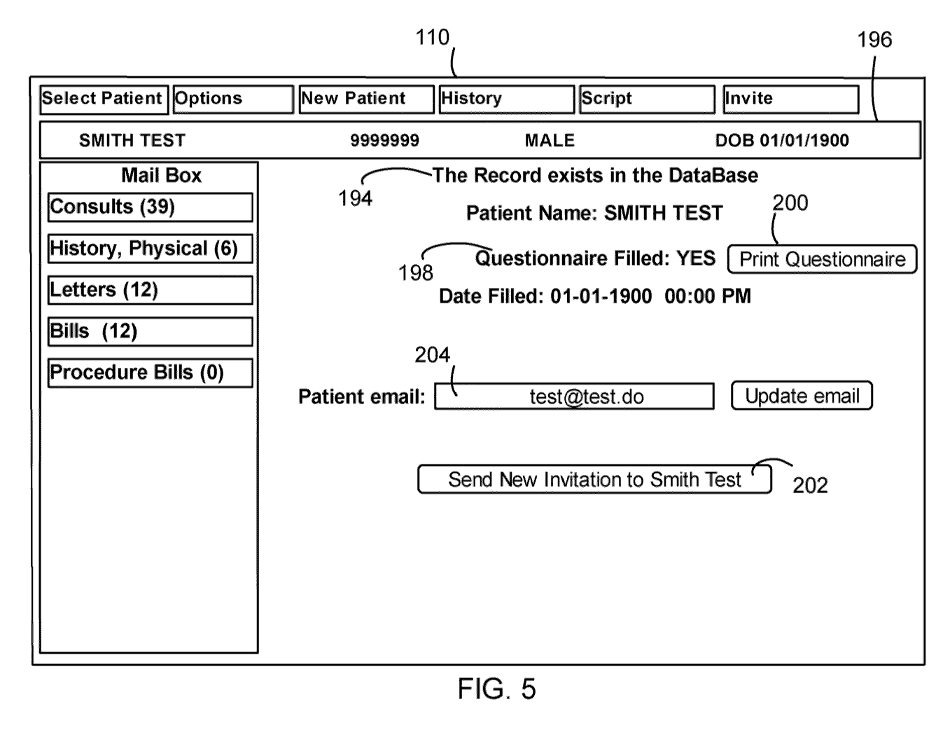

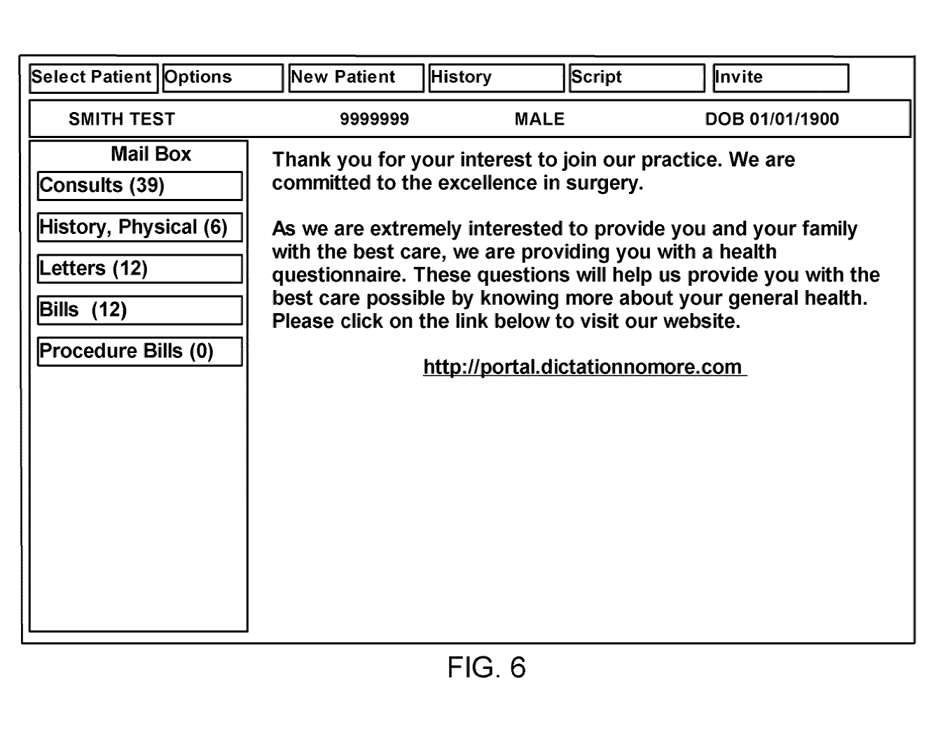

As illustrated in FIG. 5, depending on prior enrollment 194, the system 110 may have a previous record associated with the existing patient 196 based upon prior activities which may include previously collected patient information. Alternatively, the patient may be a new patient who has not been previously enrolled into the system 110. If the patient is new to the system 110, by way of example, the patient identifier may be used by the system 110 to create 170 a patient record and, as illustrated in FIG. 6, send a link or other information to the patient for accessing the system 110 and collecting 174 the relevant patient information. As illustrated in FIG. 5, if the patient identifier is associated with a previously enrolled patient 194, the previously provided patient information 140 may be accessed by the system or patient to confirm accuracy or initiate an update with any changes or supplementations. If the previous information is incomplete or if the patient is a new client who is not enrolled, the system 110 may generate a link to the patient in an encrypted manner or in an unencrypted manner, depending on the configured security settings, directing the patient to provide the relevant patient information.

FIG. 5 illustrates a navigation screen accessible to an authorized system user corresponding to an existing patient record 196 which indicates the patient information is included within the system 110 and visually highlights the presence of the previously completed questionnaire 198 and provides a hyperlink for printing 200. The illustrated screen also allows the user to send a new invitation 202 to the patient in the event the questionnaire is incomplete or missing and also provides an email address 204 of the patient for correspondence purposes. During the medical event, the medical provider or other medical office personnel may review this information with the patient and update or modify any associated Patient Information. In addition, the user may review medical history, prescriptions, or prior or pending communications sent to the client.

FIG. 5 also illustrates an invite feature 202 which allows a system user to invite a patient or other user to provide, complete or modify existing information. Generally, the system 110 is configured as a limited access system which provides access to authorized users including patients. Therefore, to access the system, each user may have a user name and password which is associated with the user and which permits authorized access. To set up the user name and password, the system may generate a user name and password for new patients which can be transmitted to the new patient for the patient to access the system. This can be done manually or the system 110 may transmit the information to the user's email account as a hyperlink through which the user may be directed to the system 110 using an internet browser application, where the user's name and password are transmitted to the system 110, which authenticates the user and permits access to the system 110. In the event the patient loses the information, the information expires or is misplaced, a new invitation may be generated by the system, revoking the prior invitation and creating a new user identification and password.

An exemplary introductory screen is illustrated in FIG. 6, in which introductory comments associated with an invitation or other communication are sent to the patient. FIGS. 7-15 illustrate exemplary questions aimed at collecting general patient information such as name, date of birth, etc. While the specific questions are not limited to those illustrated, the questions should address the areas of personal information, medical providers including any referring physician, basis for the medical concern such as a complaint and associated symptoms, current medications, past medical history, past surgical history, health maintenance history, relevant family medical history, social history and known allergies. Once the patient has completed the mandatory fields the patient may be directed to the next navigational screen or the patient may navigate to the next screen using the navigational menu by way of example and as illustrated in FIGS. 7-15.

As illustrated in FIGS. 7-15, the patient survey questionnaire form may be divided among several different pages, which may include, among others, Personal Data 806, Complaint 812, Medication 824, Past Medical History 814, Past Surgical History 816, Health Maintenance 826, Family History 818, Social History 822, and Allergies 820. FIG. 7 illustrates an exemplary Personal Data 806 questionnaire page. The fields presented may request information such as the patient's name, address, date of birth 206, gender 208, and ethnicity 210, as illustrated in FIG. 7. Using a computer with a keyboard, mouse and the display monitor and connected to the Medical Office through the Internet, the patient may provide the requested information. The received Patient Information may then be associated with the patient record and retrievably stored by the system 110. As previously illustrated in FIG. 2, the retrievably stored Patient Data 140 is available for other features like the Medical Office Module 124, Medical Image Library 126, Medical Literature Library 128 and Diagnostic Interface 130 or the Examination Module 132.

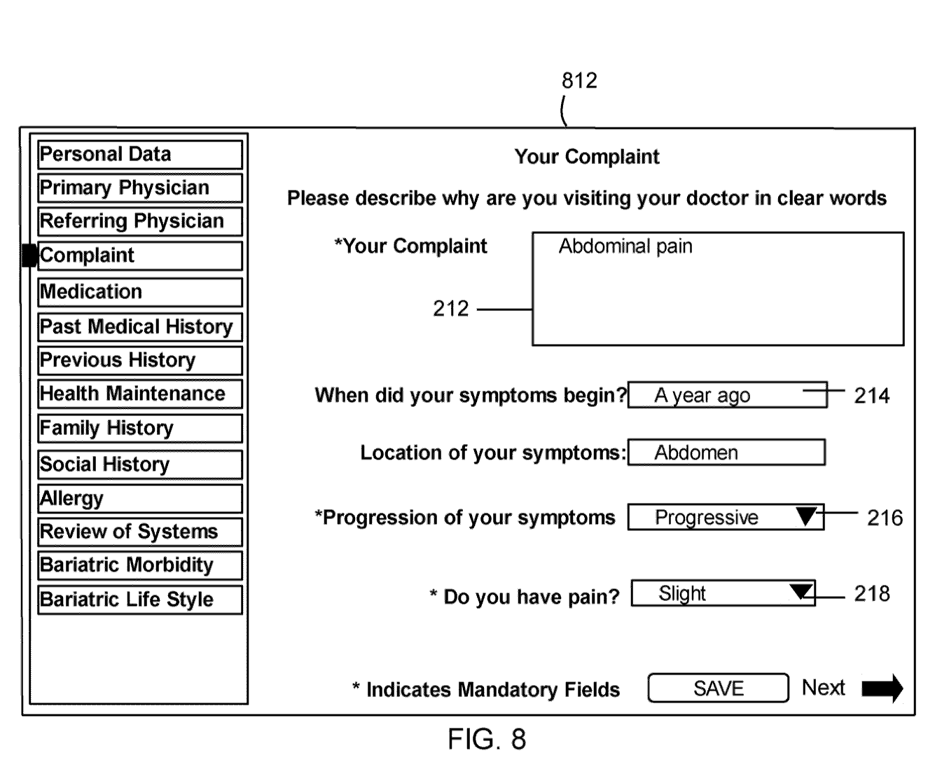

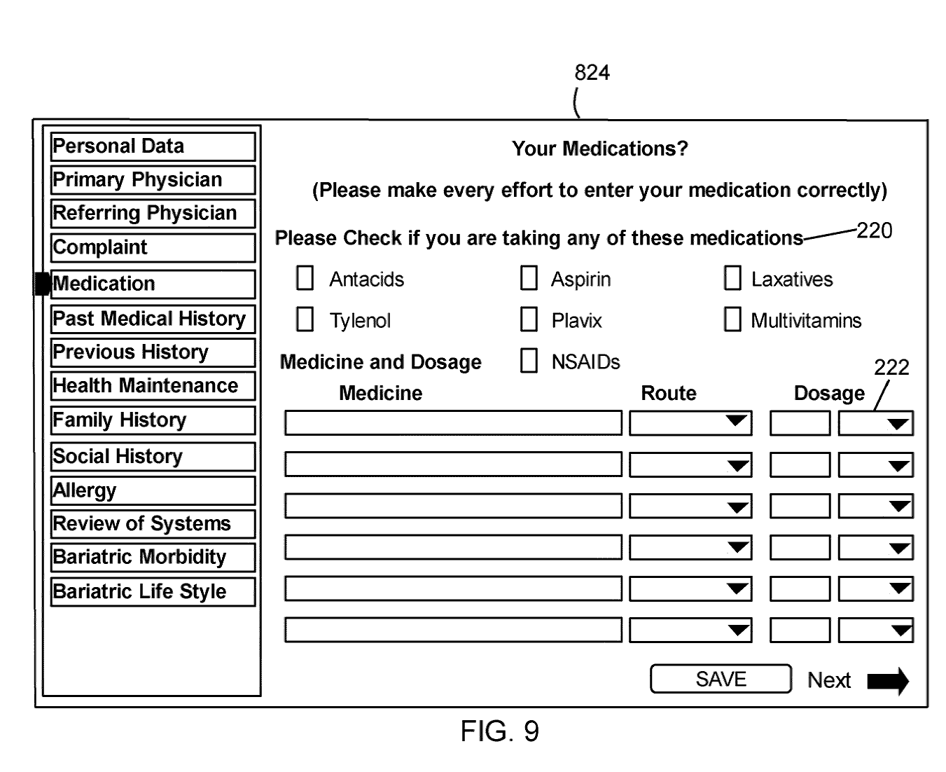

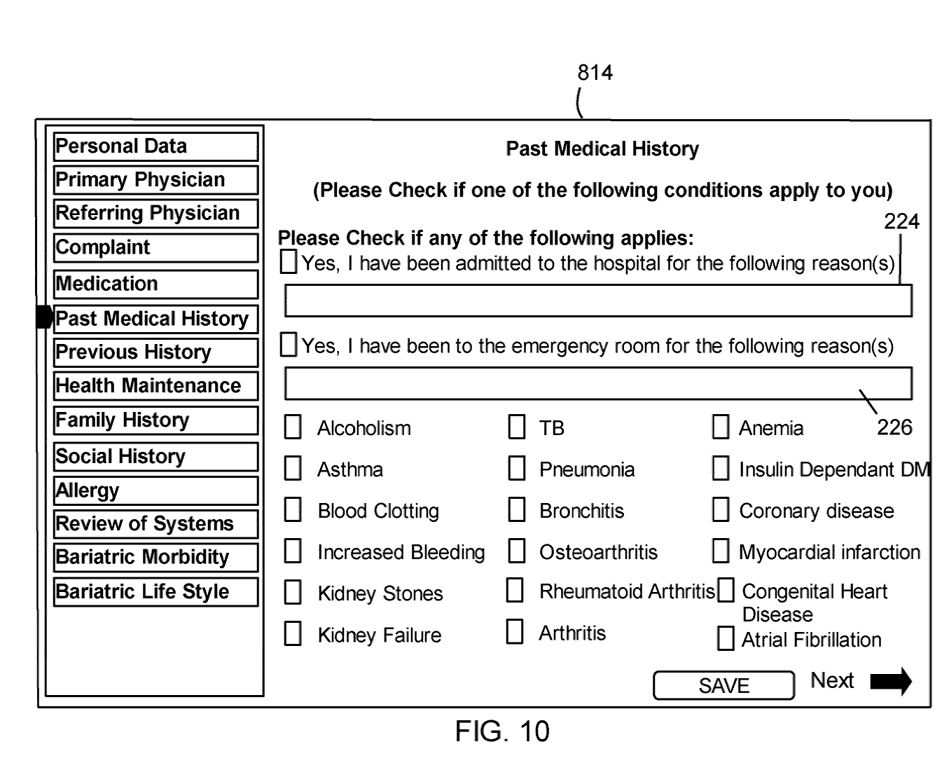

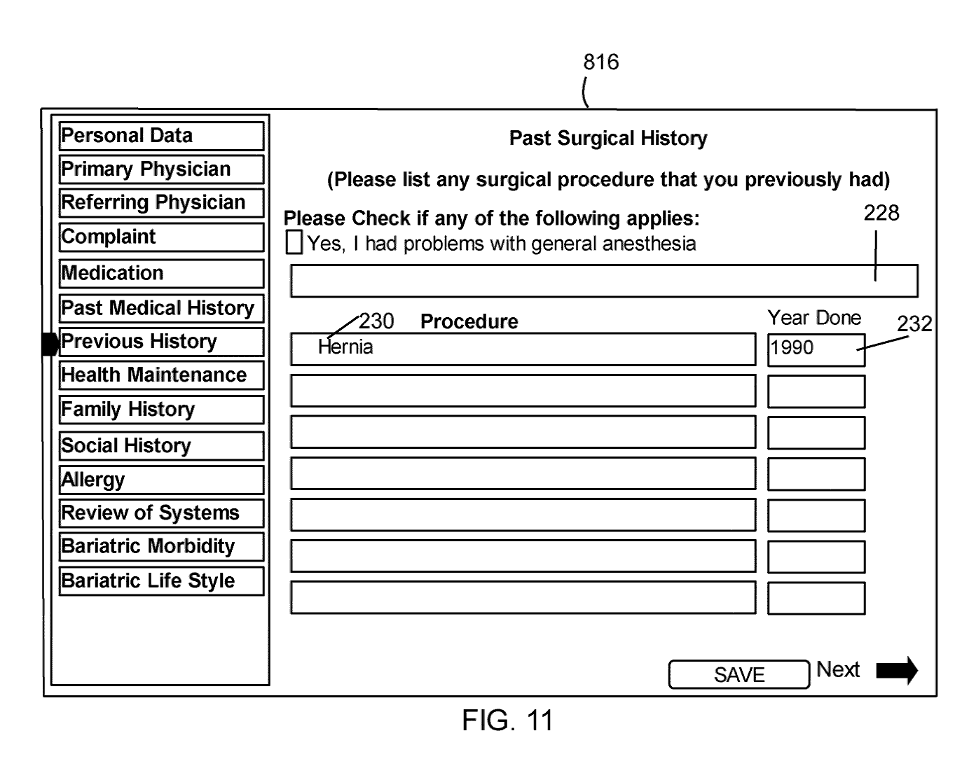

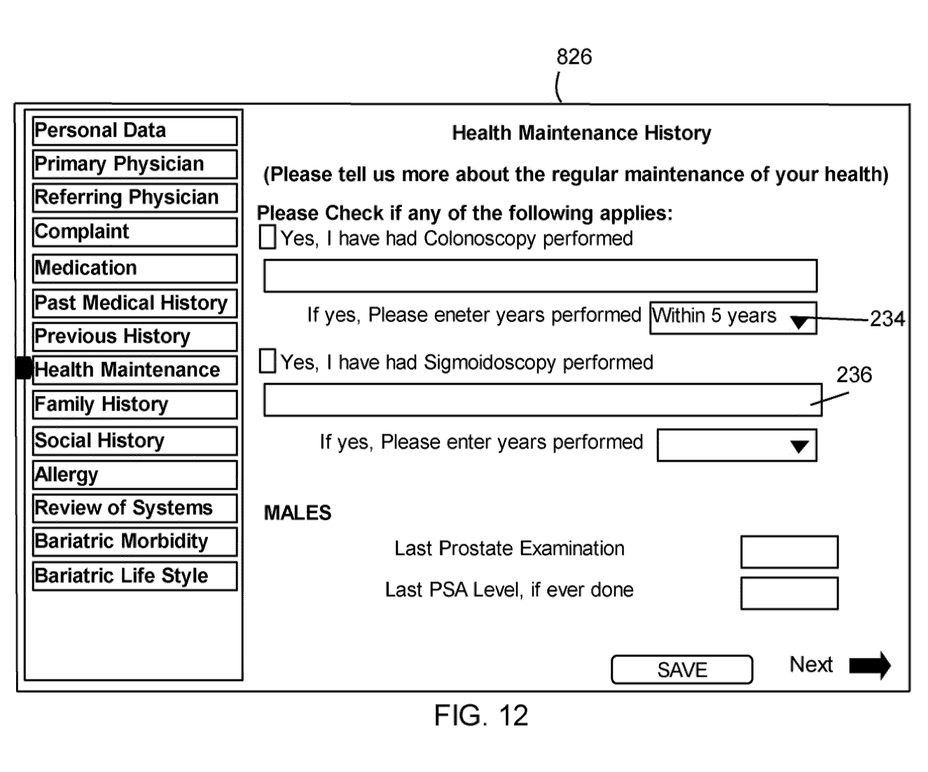

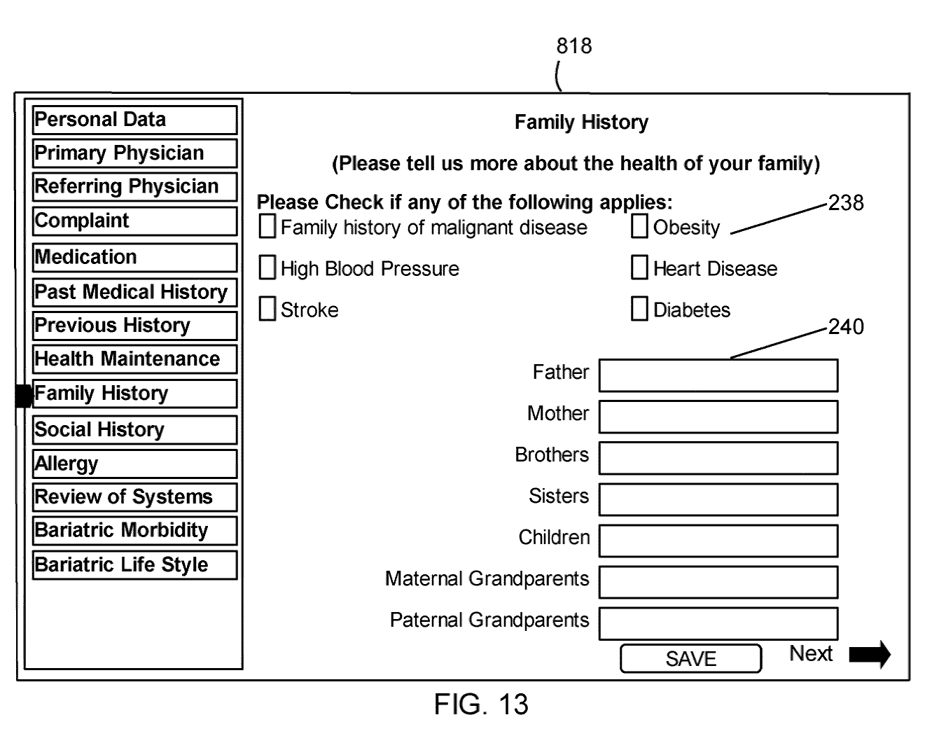

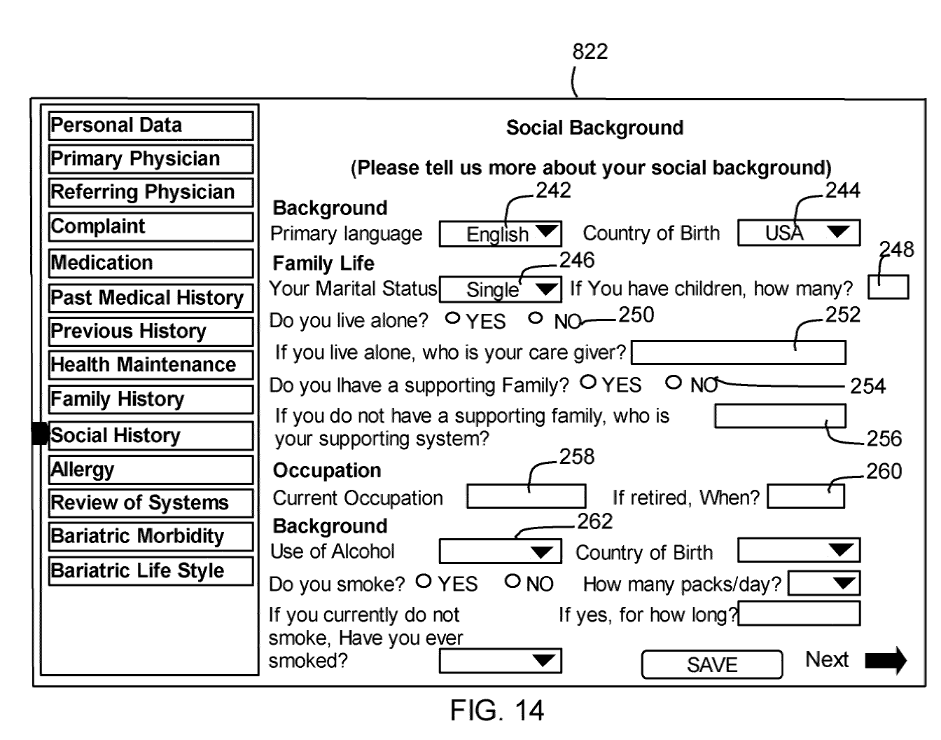

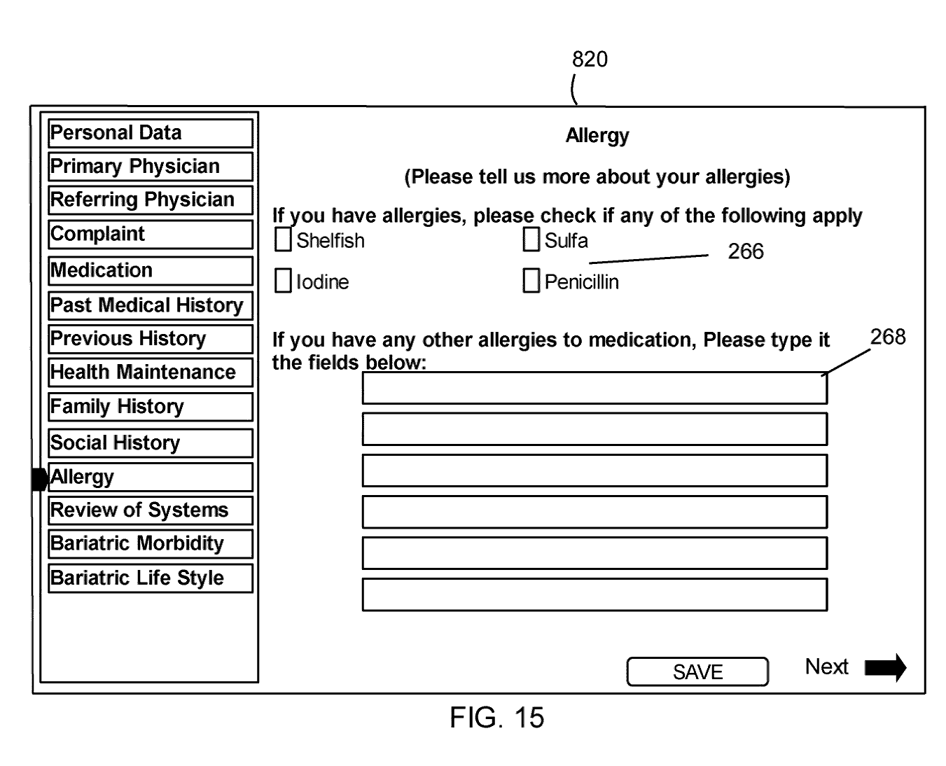

FIG. 8 illustrates an exemplary Complaint 812 questionnaire page. The fields presented may request information such as the patient's complaint 212, time the symptoms began 214, progression of the symptoms 216, and whether the patient is currently in pain 218. FIG. 9 illustrates an exemplary Medication 824 questionnaire page. The fields presented may request information such as the patient's usage of common or over-the-counter medication 220 or other medication 222. FIG. 10 illustrates an exemplary Past Medical History 814 questionnaire page. The fields presented may request information such as the patient's prior hospital admissions 224 and emergency room visits 226. FIG. 11 illustrates an exemplary Past Surgical History 816 questionnaire. The fields presented may request information such as the patient's problems with anesthesia 228, surgical procedures 230, and the year 232 a surgical procedure 230 was performed. FIG. 12 illustrates an exemplary Health Maintenance 826 questionnaire page. The fields presented may request information such as whether the patient has had a colonoscopy performed 234 or whether the patient has had a sigmoidoscopy performed 236. FIG. 13 illustrates an exemplary Family History 818 questionnaire page. The fields presented may request information such as common hereditary illnesses or conditions 238 and other illnesses or conditions family members may have 240. FIG. 14 illustrates an exemplary Social History 822 questionnaire page. The fields presented may request information such as primary language 242, country of birth 244, marital status 246, children 248, cohabitation status 250, primary care giver 252, supportive family 254, support system 256, occupation 258, retirement date 260 and use of alcohol 262. FIG. 15 illustrates an exemplary Allergy 820 questionnaire page. The fields presented may request information such as whether the patient has common allergies 266 and whether the patient is allergic to medications 268.

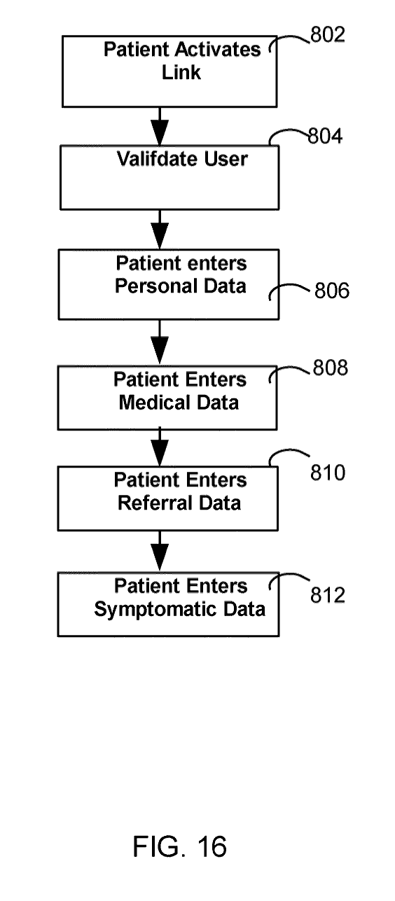

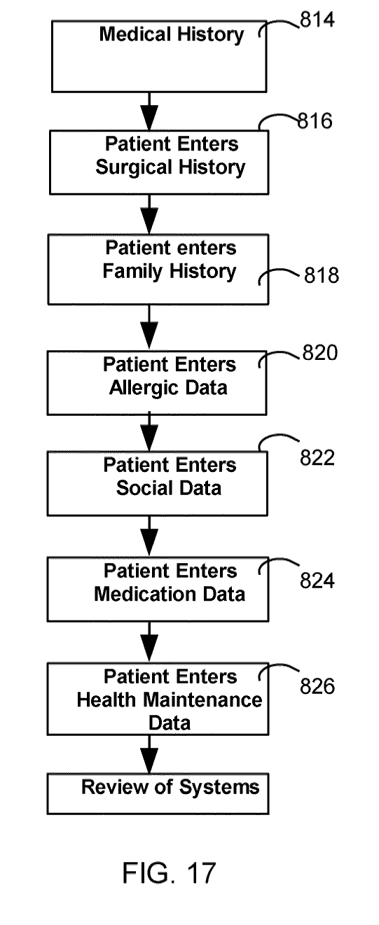

FIGS. 16 and 17 illustrate basic steps associated with the collection of patient information by the system 110. As previously indicated, automatically or upon request the system sends an electronic message to a newly enrolled or previously enrolled patient. Upon receipt of that electronic message, using a computer which may be in communication with the system via the internet or other remote communications protocols, the patient generates a return message which activates an open communication pathway between the system 110 and the patient's computer. The patient then provides validation information to the system which may be unique to the enrolled patient establishing authorized access to the patient interface feature of the configured system 110. In this way, the system limits access to those patients who have been authorized to access the system 110.

As illustrated in FIG. 16, using the previously described two-step communication protocol, the system is activated based upon the generated link 802 by the system and the system user validation 804. The system 110 may generate a historical usage event associated with the time, date, user, internet address and MAC address or other identifiers of interest for recording access to the system and verifying the authenticity of the system user. Once the system has validated the user 804, the system 110 collects personal data 806 of a patient such as health, historical or medical data 808 requested by the system 110. In addition, the system collects information related to a referring medical provider 810 or other referring party for purposes of tracking leads and ensuring follow-up communication with any referring medical providers. If a referring medical provider is designated, the system 110 associates the referring provider with the patient data for the purpose of generating reports as further described below.

After the system collects relevant patient data, symptomatic data associated with the scheduled medical event is collected 812 and retrievably stored for later use. In this way, the system 110 maintains a historical log of what conditions or symptoms are identified by the patient as being of concern. By providing a remote interface screen with guided instructions, the user is prompted to provide additional details not traditionally elicited during typical clinic visits to the medical office or with the medical provider. The guided instructions facilitate the collection of additional patient data and provide a way to review, modify or update the information at the patients' convenience and to print out the information from the selected screens for review, storage within the system, transmittal to the medical office or hand delivery as needed to the medical office or medical provider, or for the patients' own use.

As illustrated in FIG. 17, after collecting symptomatic data as illustrated in FIG. 16, the system 110 collects historical information including medical history 814, surgical history 816, family history 818, information related to adverse reactions 820, information related to the patient's social influences 822, historical medication information 824 and health maintenance information 826.

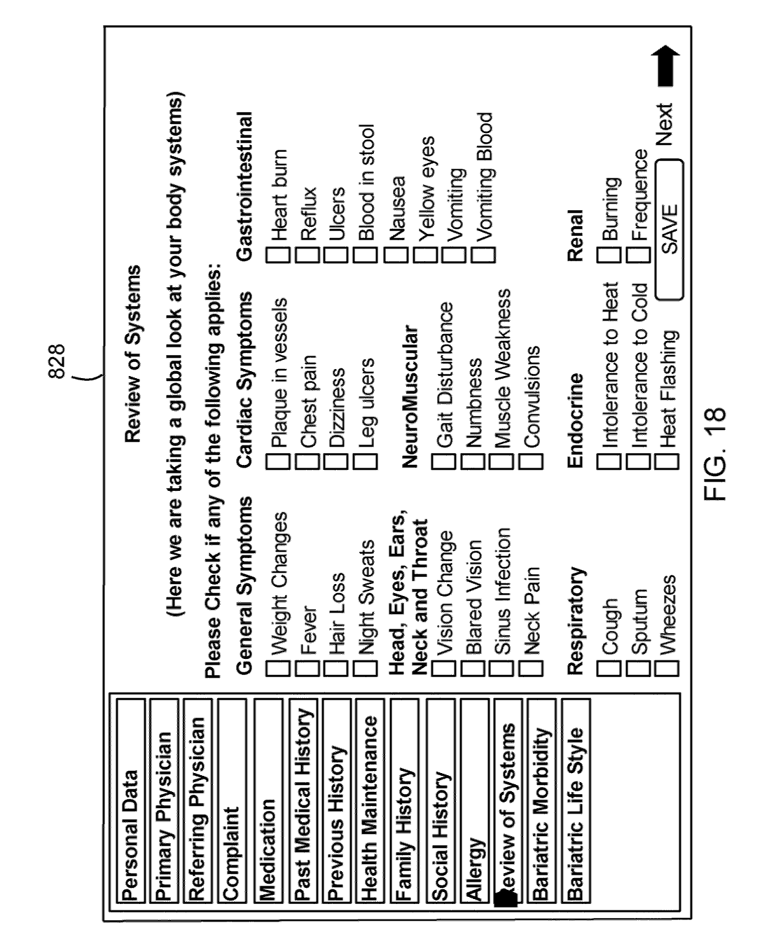

FIG. 18 illustrates a Review of Systems 828 screen which displays a series of data entry fields designed to collect information from the patient regarding potential symptoms related to various biological systems. The data entry fields are configured and arranged to generate a series of questions from which the system may categorize a medical condition based upon the collected patient information. In addition, the system 110 may trigger additional entries for collecting additional patient information based upon the categorized medical condition. In this way, the system 110 may help streamline the medical event by focusing or targeting specific medical categories for review by the medical provider.

Once the patient information has been collected, the system 110 may verify the information for completeness or inconsistencies and then allow the user to review the collected information using the illustrated navigational feature located, for example, on the left side of the screens illustrated in FIGS. 6-18, while allowing for modification as necessary.

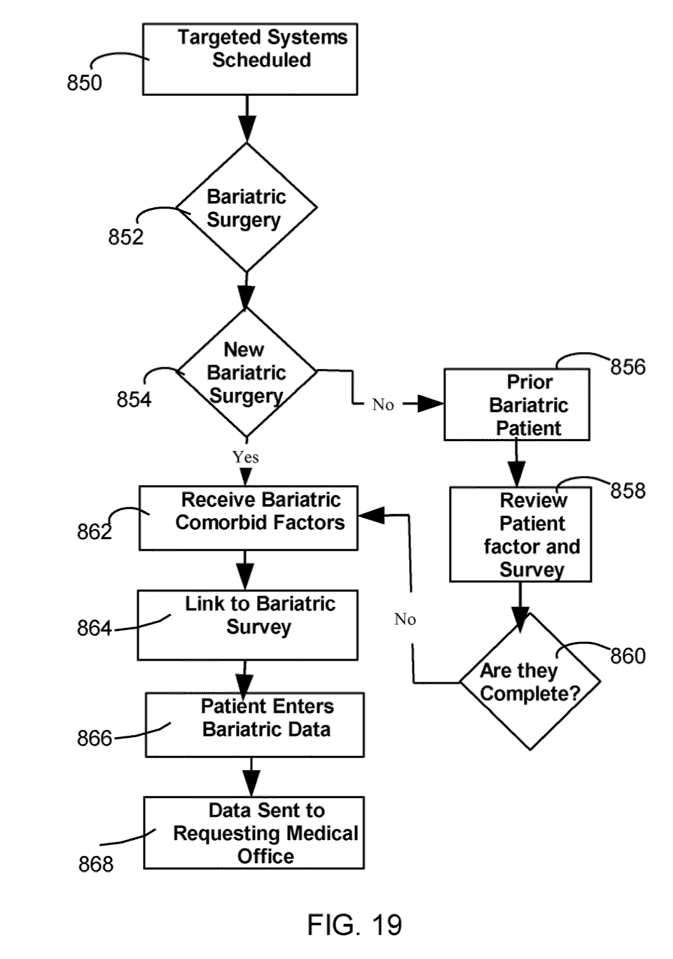

An example of the operation of an embodiment of the invention involves, as illustrated in FIG. 19, a review of the targeted system 850 during which a decision 852 is made whether bariatric surgery is to be scheduled. Depending upon whether bariatric surgery is scheduled, the system then determines if the patient is a new bariatric patient 854 or if they are an existing bariatric patient 856. If the patient is an existing bariatric patient, the system 110 will review 858 whether the factors and survey questionnaire have been completed 860. If not, or if after review by the patient additional information or modifications are necessary, a link may be generated by the system to collect additional information related to the co-morbid factors 862 or a link may be generated 864 by the system 110 for the collection of bariatric data 866. Once the system has collected information related to the triggered or scheduled medical condition, the information is transmitted to the medical office 868 for association with the patient identifier.

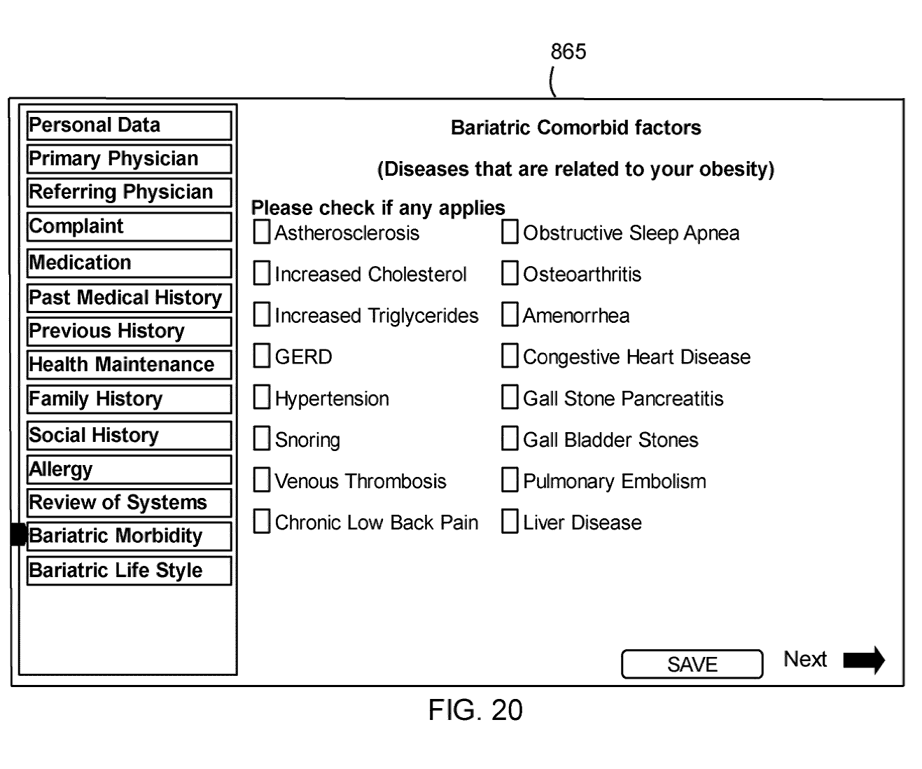

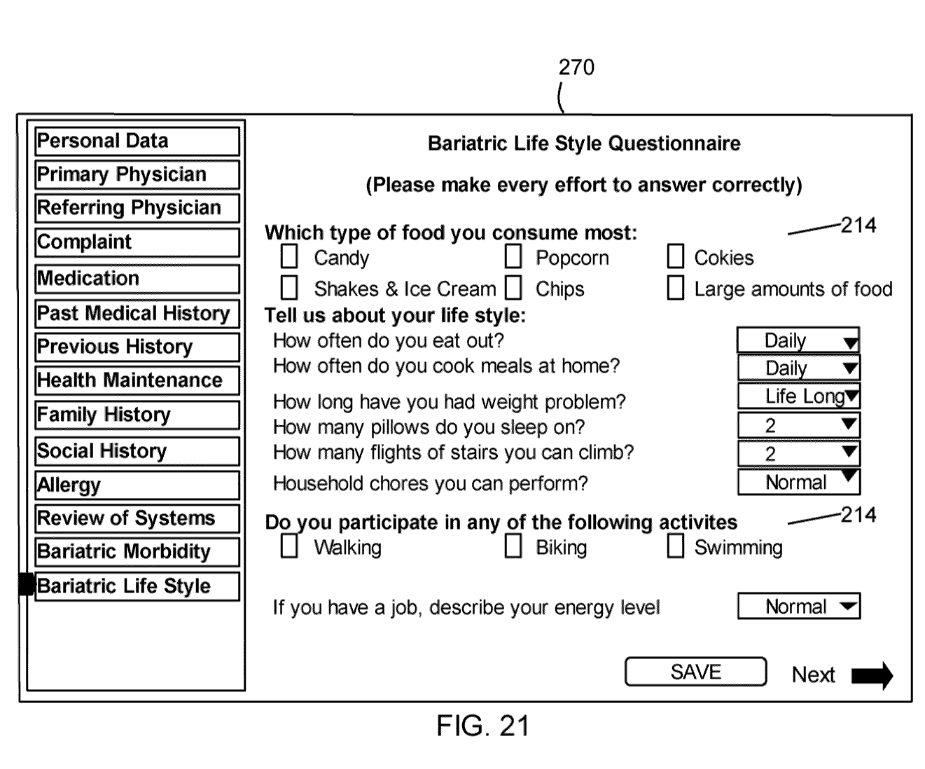

In addition, depending on the scheduled medical event, additional informational screens may be provided for collecting specific information related to the selected or targeted medical condition. By way of example, FIG. 19 has a flow chart illustrating the collection of exemplary information related to bariatric surgery, the targeted medical condition. As further illustrated in FIGS. 20 and 21 additional screens may be presented by the system 110, based upon the targeted medical condition, to collect additional information related thereto. For example, as illustrated in FIG. 20, additional factors 865 may help diagnosis the degree or extent of the targeted medical condition. Screening the patient for various symptoms related thereto may be beneficial for diagnosing the condition.

As illustrated in FIG. 21, taking a holistic view of the patient, information related to tangential systems and ancillary systems may be relevant towards the patient diagnosis, and information related to these additional systems may be relevant for purposes of the scheduled medical event. Because these additional systems may impact the patient diagnosis, utilizing additional screens the system 110 may collect additional information related to various systems and symptoms. After this information is collected by the system 110, it is retrievably stored within the storage device 44. In this manner, the system 110 provides for enhanced information collection techniques by presenting generally standardized questions related to the patient, collecting the responses, and organizing them for storage in an electronically retrievable manner. During the generalized collection process additional information may become beneficial and as such the system 110 may generate additional screens for collecting the additional information from the patient. If no additional information is required, the system 110 stores the recorded information on the storage device 44 for retrieval during the medical event at the medical office.

Additionally, during the information collection process a predefined trigger or condition may occur which will allow the system 110 to generate additional screens or forms from the form repository 120 related to a triggered medical condition.

Once all patient information has been collected and retrievably stored on the storage device 44, the patient is ready for the scheduled medical event at the medical office. During the scheduled medical event 160 a medical provider or other medical office personnel may login to the system 110 to verify or review the collected information prior to the scheduled medical event 160. In the event additional information may be desired prior to the scheduled medical event 160, the system 110 may generate a message to the patient requesting the additional information through a system generated hyperlink or link.

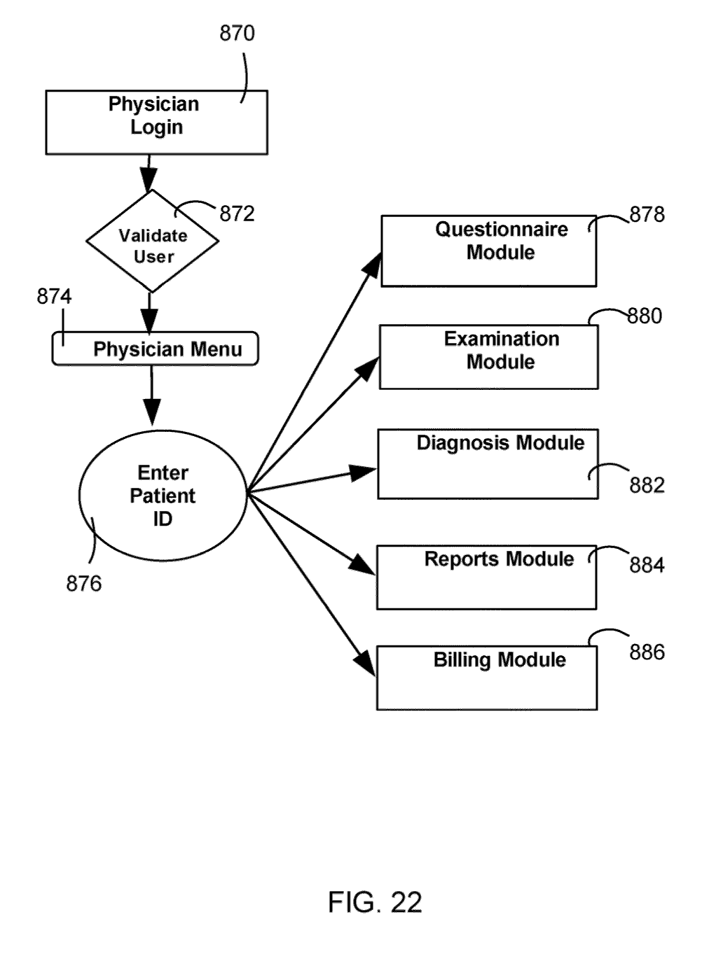

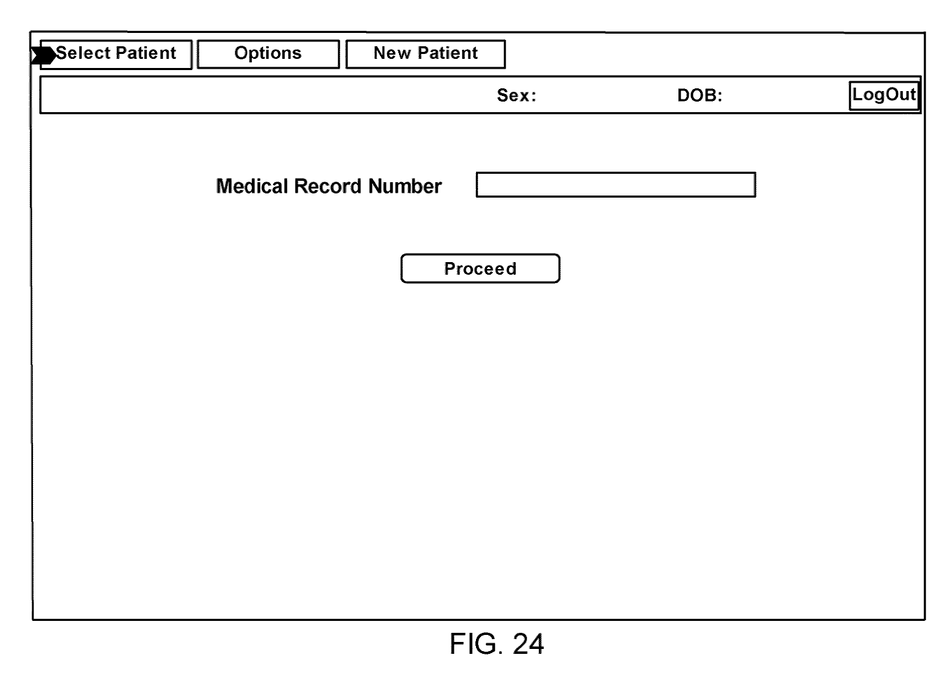

As illustrated in FIG. 22, a medical provider such as an MD, DO, DDS, RN, LPN, PRN or other medical provider may access the system 110 by logging 870 into the system using an authorized password and user name. Once the system 110 validates 872 the user, the medical provider menu screen is displayed 874. An example of a medical provider menu screen is illustrated in FIG. 24. Once the menu screen appears, the medical provider can provide a patient identifier 876 and can then assess various system functions like a questionnaire module 878, an examination module 880, a diagnosis module 882 a reports module 884 or a billing module 886.

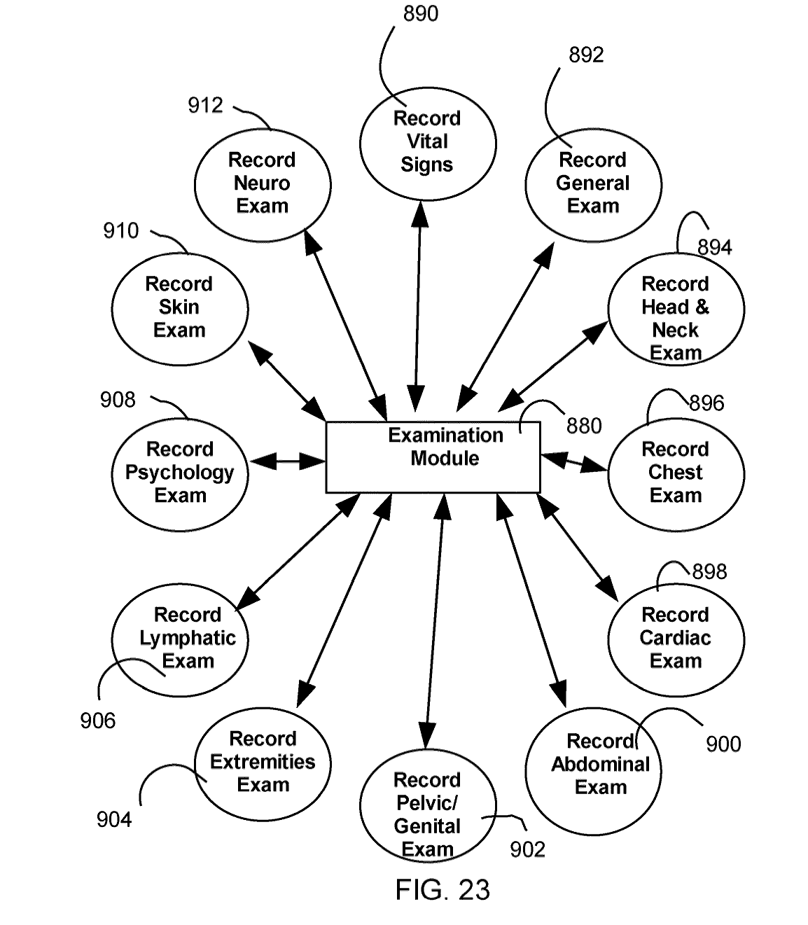

As illustrated in FIG. 23, some of the examined biological systems may include general information 892, head and neck 894, chest 896, cardio 898, abdominal 900, pelvic and genital 902, lymphatic 906, psychological 908, epidural 910 and neurological 912 biological systems. In the preferred embodiment, the Examination Module 880 will include navigable screens associated with each of these biological systems. To expedite the examination process and to ensure the collected patient information is accurate, the system will populate the navigable visual screens with the relevant patient information collected during the Questionnaire Module 878. The system 110 will provide visual screens related to each of these biological systems. However, it may be desired to customize the various screens for the specific medical provider or medical office. Therefore, the system 110 may also include a customization feature related to the navigable visual screens to tailor the screens as desired by the user.

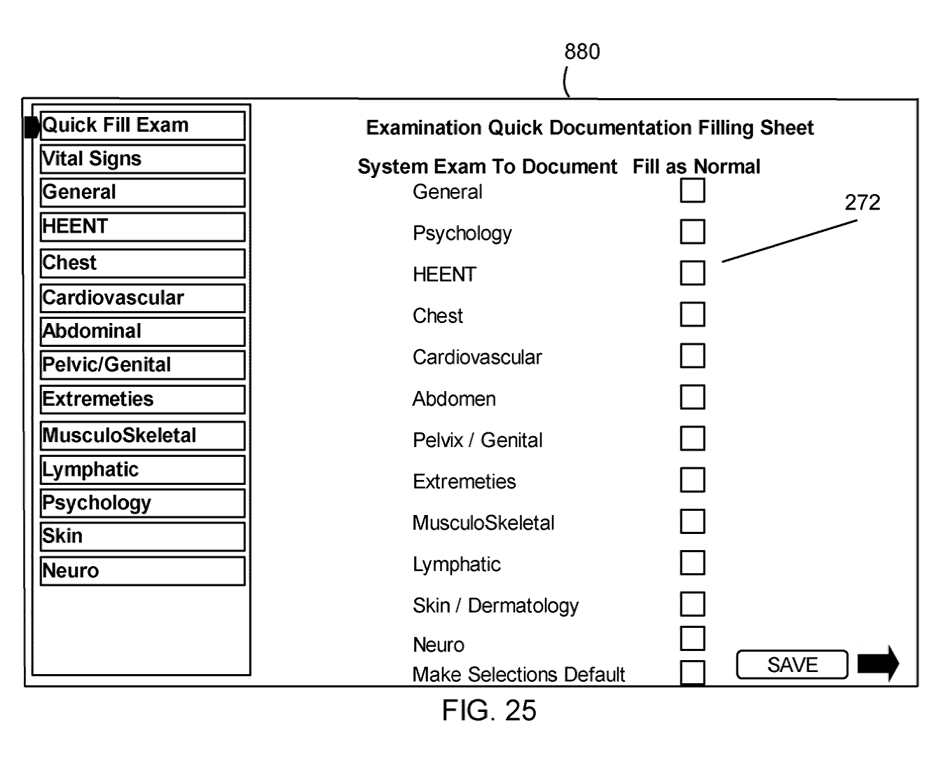

The questionnaire module 878 allows the user to review the system generated forms and associated patient information corresponding to the patient identifier provided by the user. As previously indicated, the patient information was collected by the system 110 during the patient information collection process. As illustrated in FIGS. 25, 26, 29, and 30, the Examination Module 880 provides visual screens organized in a logical manner and presented with automated navigation features to allow the user to conduct a medical examination for various biological systems. The Examination Module 880 retrieves patient information collected by the Questionnaire Module to display relevant stored patient information populated on visual screens during the examination process. For example, if the patient has indicated that they use hearing aids, the system 110 may identify this disability and display the disability during the HEENT biological system examination screen. During the Examination Module 880, the user can review the patient information previously collected while providing an annotation feature for editing the displayed patient information contained on the visual screens. In addition, during the Examination Module 880, the user may be prompted to supply information or the user may be navigated through the Examination Module 880 by the displayed screens until the patient examination is completed. In addition, the user may select additional reports to be created at the conclusion of the examination process or the user can select various images or medical literature to distribute to the patient.

In an alternative embodiment, the system may provide a facility for recording the examination including the aural or visual elements. A recording device in communication with a microprocessor and located generally within the examination area may be provided for recording and transmitting the recorded information to the microprocessor. In this way, the user can capture and record the patient status and the status of various medical conditions in a way which may not be available using standard paper forms. The recorded information can be associated with the patient file and access to the recorded information can be limited according to the policies and procedures of the medical office or otherwise. Recorded information may be retrievably stored by the system 110 for later use as desired by the user. Because the recorded information is generally easily reproducible, it provides a persuasive recording of the relevant medical event and any associated conditions for evaluation and review after the conclusion of the Examination Module 880.

During the examination process the system 110 will present a variety of visual screens to record the current condition of various biological systems. There are more than a hundred biological systems associated with the human body which may be examined during the scheduled medical event which are divided into major biological systems and specialty biological systems. Generally, however, during a typical patient examination, the examining medical professional will review between ten to thirteen systems. During the examination, the system 110 provides a visual screen or a series of visual screens which have been populated with previously collected patient information and which allows the medical professional to provide additional information or otherwise edit or change the displayed patient information depending upon the examination or other medical event.

Generally, the Examination Screens allow for recording of observed patient information by the medical professional during the medical event, including patient signs observed by the medical professional. However, the system 110 also provides a feature to populate all or only selected examination screens with preconfigured data. Prepopulating the Examination Screens with the desired data allows the user to customize the Examination Module to address the medical professional's concerns. In addition, the Examination Screens can be pre-populated with the last recorded data or the system may auto generate the preconfigured data based upon a statistical analysis of common medical symptoms. By prepopulating the examination screens, the medical professional can focus attention on relevant medical concerns without distraction while still recording the general status of various biological systems. The preconfigured default data may be representative of a typical examination, or it may be modified as desired. Various triggers, flags, alarms or alerts may be configured to ensure the quality and comprehensiveness of the collected medical information. For example, if the patient has revealed that he is taking medication to treat a specific cardiac condition and if the medication has known adverse reactions which are consistent with an observed or reported medical condition, the system 110 may prompt the medical professional to inquire further regarding the medication at issue. In this way, the system 110 optimizes the resources of the medical professional and the medical office during the medical event.

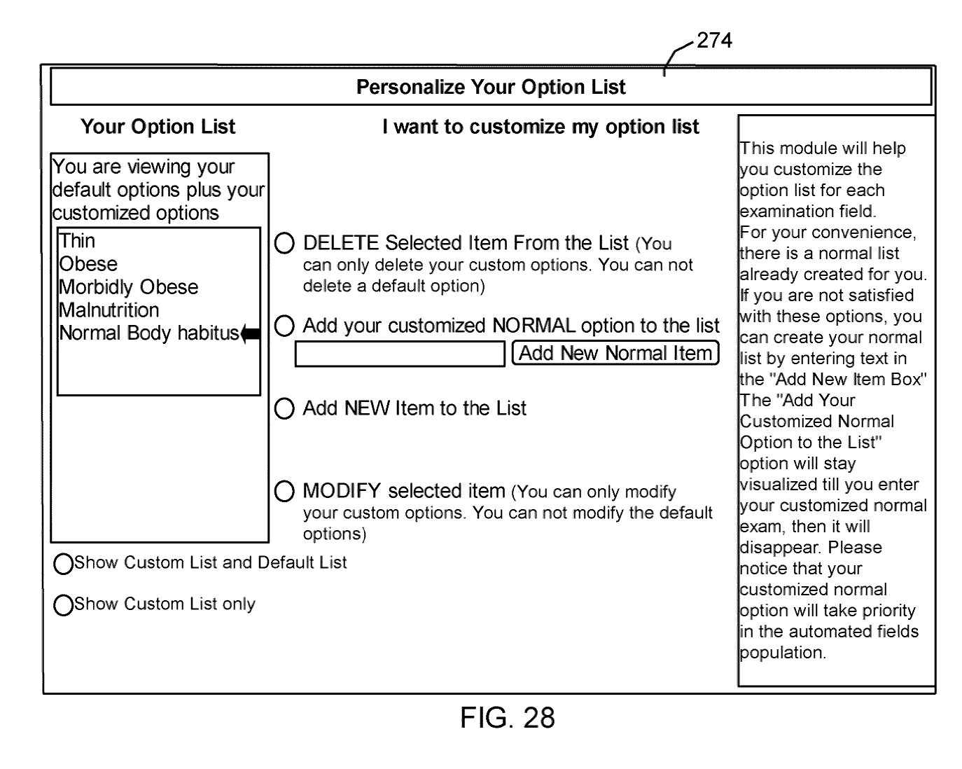

To further facilitate the recording of the medical information, the system 110 provides a number of screens with typical signs depending on the designated medical event. Each sign within the pre-populated listing of typical signs includes a list of medical characteristics of interest allowing the medical professional to provide additional comments related to the observed signs. To select the desired comment, the medical professional may navigate through the pre-populated listing of comments, selecting the desired comment. Once selected, the chosen comment is inserted in the medical characteristic of interest field. In addition to selecting from the pre-populated listing of comments, the medical professional may provide their own comments, as illustrated in FIG. 28, unrelated to a selected sign, the comments being generally associated with the retrievably stored patient information. Sensory comments may be shared and exchanged between various medical professionals or other system users using the system messaging feature.

As previously described, generally, relevant patient information is collected during the Questionnaire Module 878 and the recorded medical information is recorded during the Examination Module 880 by the medical professional.

As previously described, during the Examination Module 880, the system 110 can provide an automated quick exam feature in which the system auto generates the examination information related to selected biological systems using preconfigured default information. Additional information may be obtained and utilized from the previously collected patient information which was collected during the Questionnaire Module 878. As illustrated in FIG. 25, the system 110 can provide this feature for individual biological systems or it can provide it for all biological systems. In this way, the examination can be recorded by way of as little as one click 272, allowing for the auto generation of relevant medical documentation. In this way, the medical professional may populate the Examination Screens prior to viewing them with default data and simply make any required modifications to patient biological systems which are observed to be abnormal. After pre-populating the examination information, the user can navigate to each examination screen and selectively edit the desired field.

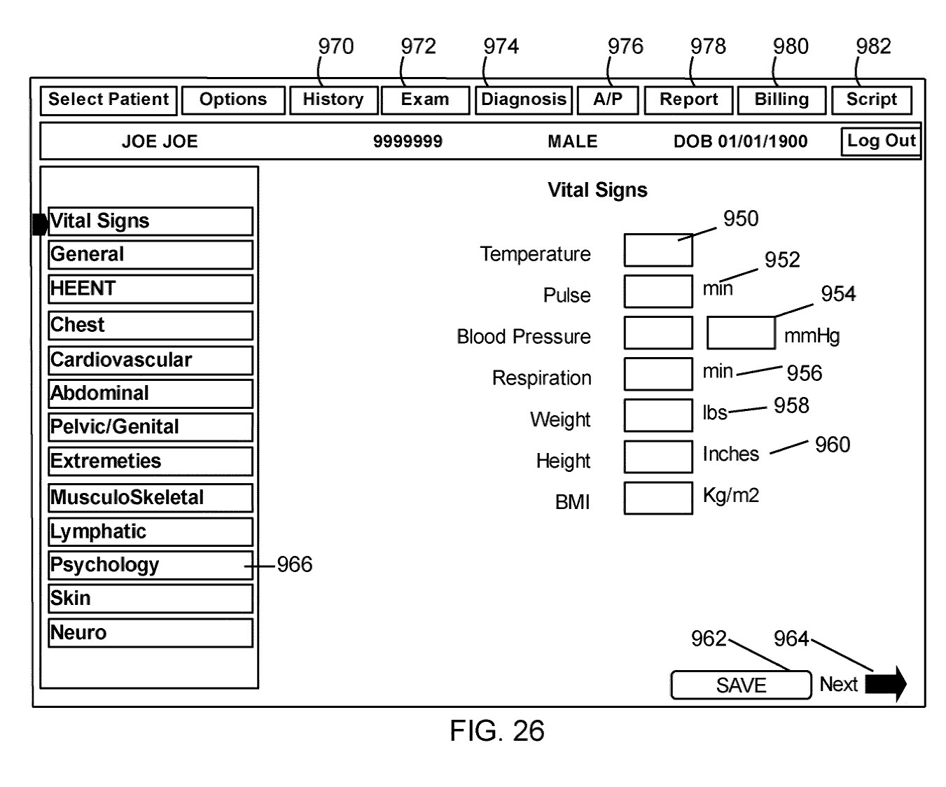

An example of an examination screen is illustrated in FIG. 26 with a Vital Signs examination screen adapted to receive recorded examination data like temperature 950, pulse 952, blood pressure 954, respiration 956, weight 958 and height 960 fields. Each of these fields may be manually entered by the user or they may be automatically recorded by various sensors associated with the patient. In addition, the user may navigate to various sections using the listing of screens or pages which appears within a navigational menu 966, adapted for allowing the user to navigate between different screens. These entries are in hypertext and allow the patient to reach subsequent screens by clicking on the respective name or title. Alternatively, the system provides for step by step navigation, allowing the user to navigate to the next subsequent screen after each screen is completed.

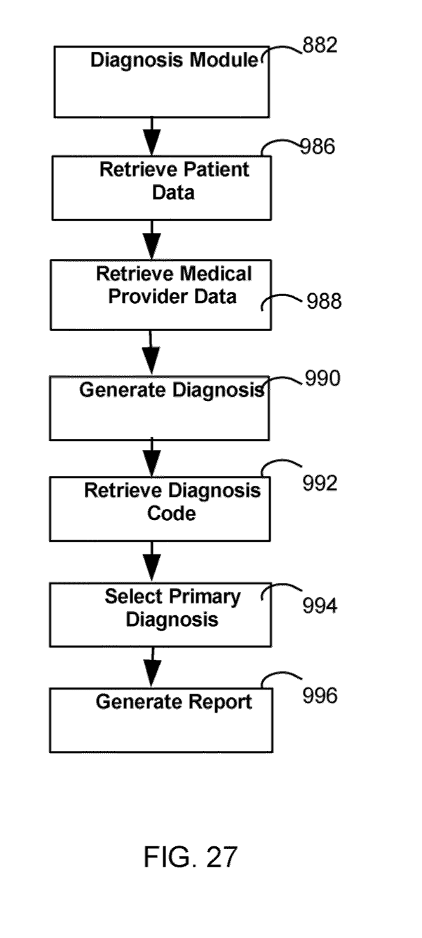

As illustrated in FIG. 27, the Diagnosis Module 882 provides steps for retrieving patient data 986, retrieving medical provider data 988, generating diagnoses 990, retrieving diagnosis codes 992, selecting a primary diagnosis 994 and generating a report 996. In the preferred embodiment, the Diagnosis Module 882 will include navigable screens associated with each of these steps. For speed and accuracy of diagnosis, the system will populate the navigable visual screens with the relevant patient information collected during the Questionnaire Module 878. While the system 110 will provide visual screens related to each of these diagnosis steps, it may be desired to customize the various screens for the specific medical provider or medical office. Therefore, the system 110 may also include a customization feature related to the navigable visual screens to tailor the screens as desired by the user.

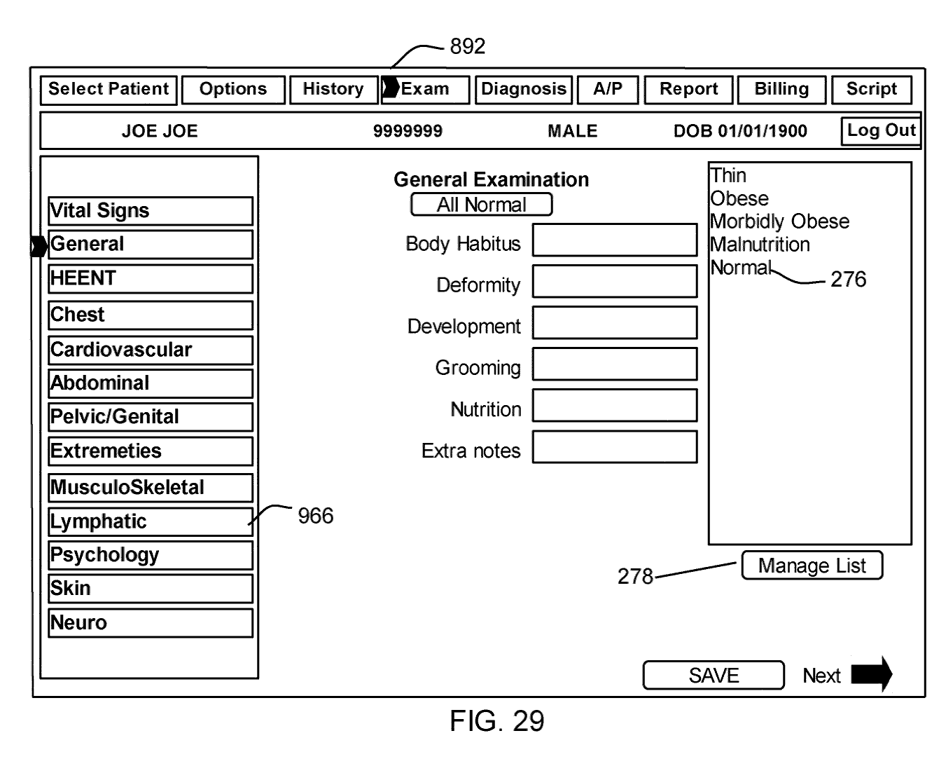

FIG. 28 illustrates an examination customization screen where the user can create custom entries for each field associated with the various biological systems reviewed during the Examination Module. The user can modify the default selection for the field and can provide alternative selections for each field. The customization 274 can be done by the medical professional at the time of the examination or by a system user during configuration of the system or during periodic maintenance of the system 110. During the Examination Module, as illustrated in FIG. 29, the user can select the appropriate listing for the relevant field from a listing associated with each field which was provided during the examination field customization screen illustrated in FIG. 28.

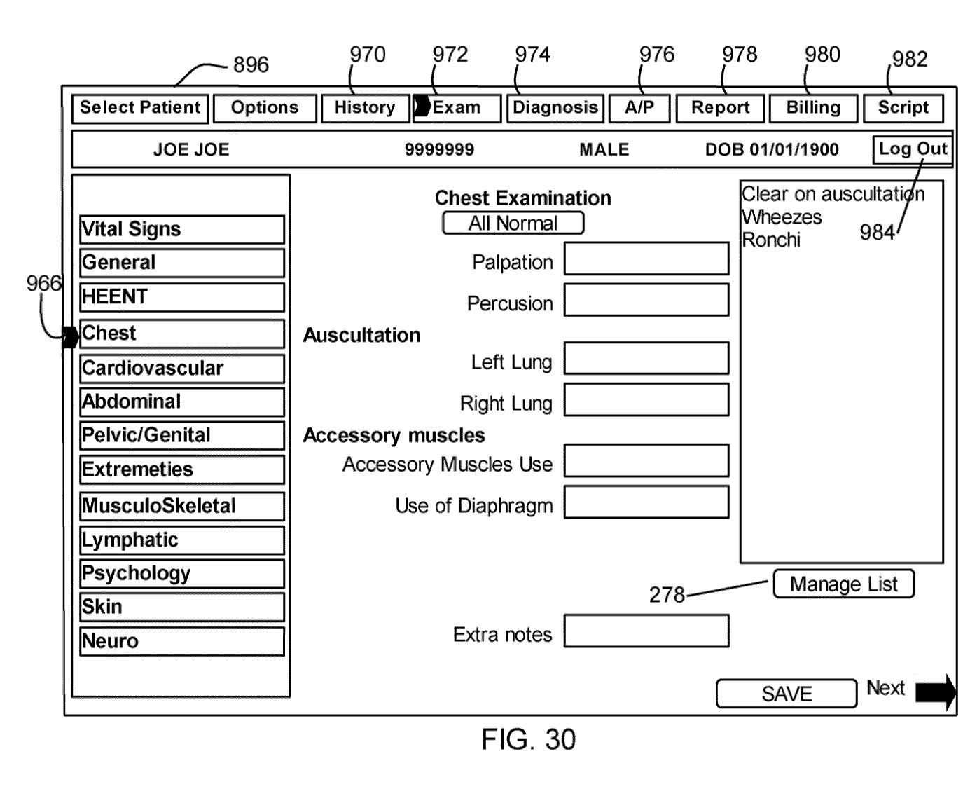

As illustrated in FIG. 29, the examination field customization screen may be accessed by selecting the Manage List button 278 located on the right side of FIG. 29. In addition, as illustrated in FIG. 30, the medical professional may enter manual notes 276 during the Examination Module 880 or may use the All Normal 280 feature to pre-populate the screen with predefined normal values. The examination screen may also include a feature to save the entered information in the event the user needs to exit out of the system. The examination screen also provides a step-by-step navigation feature for navigation by the system upon completion of the required fields within each examination screen. Alternatively, the user may jump to different examination screens using the navigation menu 966 located, for example, on the left of the displayed examination screen. The user may also navigate through different areas of the system 110 from the historical tabs 970, the examination tab 972, the diagnosis tab 974, accounts payable tab 976, reporting tab 978, billing tab 980 or the prescription tab 982. In addition, the user may logout 984 of the system as needed.

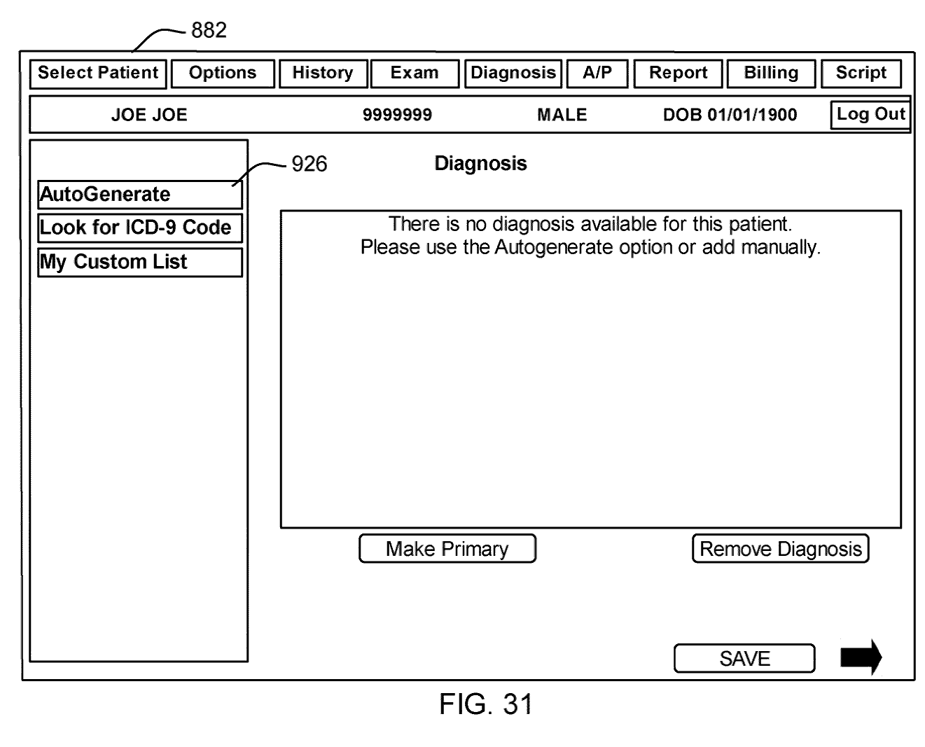

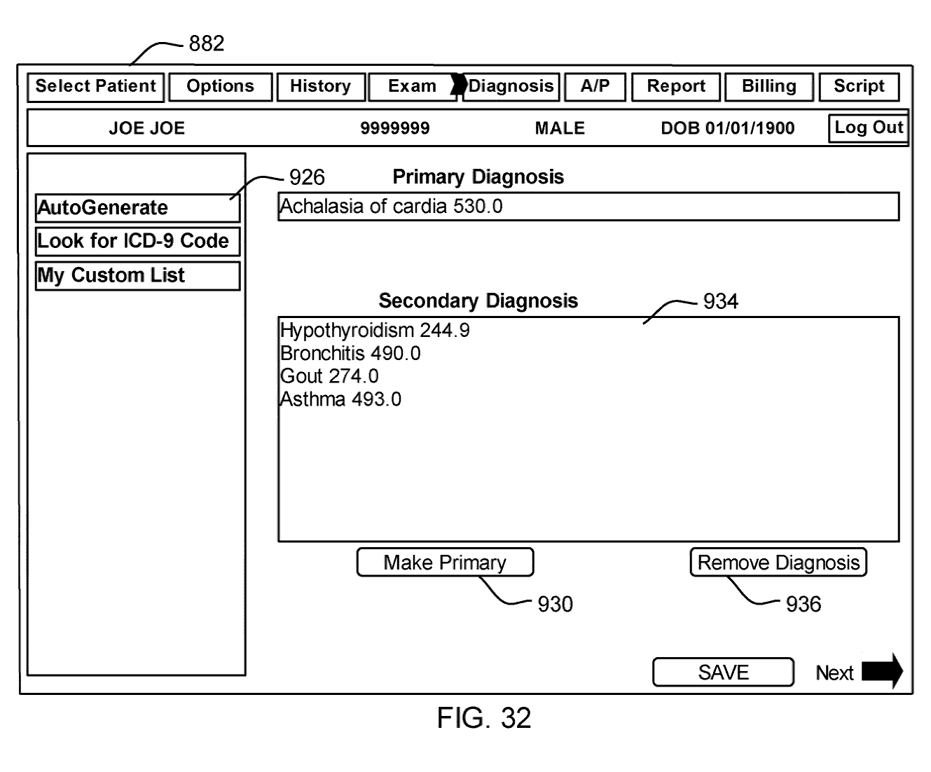

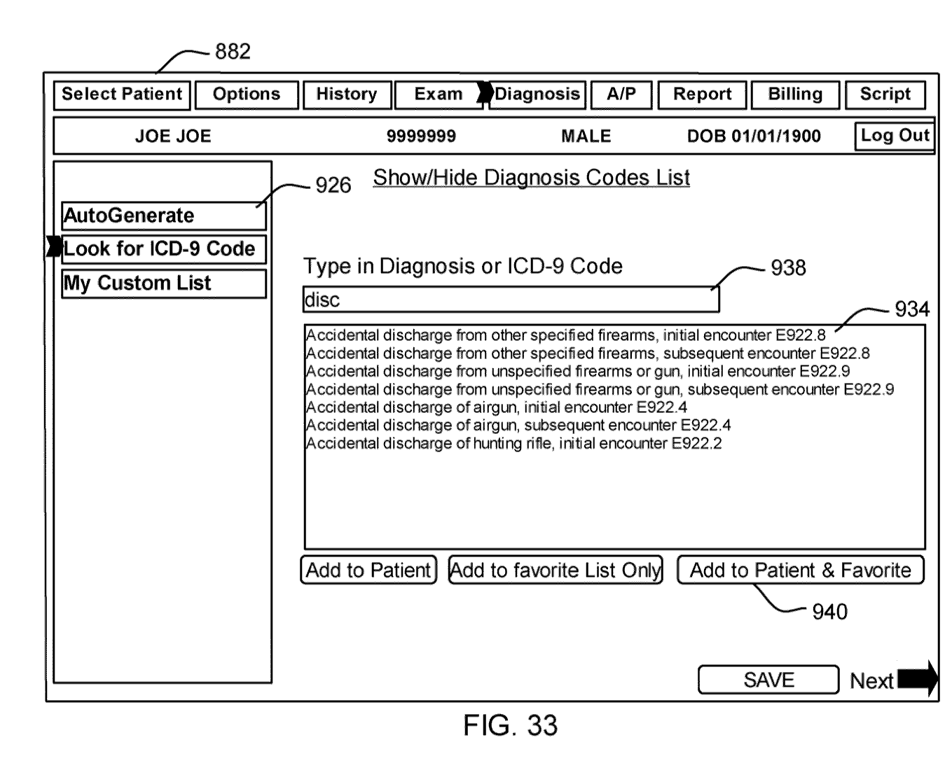

As illustrated in FIGS. 31-33, the Diagnosis Module 882 provides visual screens pre-populated with the patient information retrieved from the storage device. During the Diagnosis Module 882, the system 110 also retrieves and pre-populates the medical provider data into the relevant visual screens. As illustrated in FIG. 31, the system may auto generate a diagnosis 926. As further illustrated in FIG. 32, once a listing of diagnosis is generated, the user may select a diagnosis 934 and make it a primary diagnosis 930 or the user may remove 936 or add a diagnosis to the listing. Any diagnosis not selected as primary within the listing of diagnosis will be listed as a secondary diagnosis. The system 110 uses patient information collected during the Questionnaire Module 878 and recorded medical information recorded during the Examination Modules 880 to generate a default diagnosis listing for the selected biological systems. During the Diagnosis Module 882, the user may auto generate a diagnosis 926 or manually look-up a relevant diagnosis 938 from a provided listing 934 of diagnosis as illustrated in FIG. 33. The user may also look up the diagnosis from a user generated listing of common diagnoses. The user may also add a diagnosis from the provided listing to the user's favorite or custom diagnosis listing and associate it with the selected patient 940, providing ready retrieval of the medical diagnosis during subsequent Diagnosis Module 882 usage.

Using the Auto generate 926 feature the system 110 sorts through the collected patient information and the recorded medical information to create a list of possible diagnosis. The user may assign a primary diagnosis from the list to correspond to the scheduled medical event. The user may also remove a diagnosis from the list or the user may create a diagnosis to add to the list. The remaining diagnoses not removed from the list, become secondary diagnoses for the purpose of the scheduled medical event. In addition to creating a list of diagnosis, the system 110, matches relevant diagnosis using standardized medical diagnosis codes contained within the system 110, such as the ICD-9 coding. If any desired code is not present, the user may look up the code from within the system 110 or from a third party sourced referenced by the system 110.

The diagnosis selection screen illustrated in FIG. 32 is based upon user selections which are presented in an organized and logical manner. In addition, FIG. 32 illustrates the diagnosis customization feature which allows the user to customize the common diagnosis during the Diagnosis Module 882. Using the navigable visual screens the user is allowed to generate a diagnosis 926 and associate a relevant diagnosis code 890 to each selected diagnosis while designating a primary diagnosis 930. Upon the conclusion of the Diagnosis Module 882, the user can generate reports featuring the desired information from the system collected during the Questionnaire Module 878, the Examination Module 880 and selected during the Diagnosis Module 882.

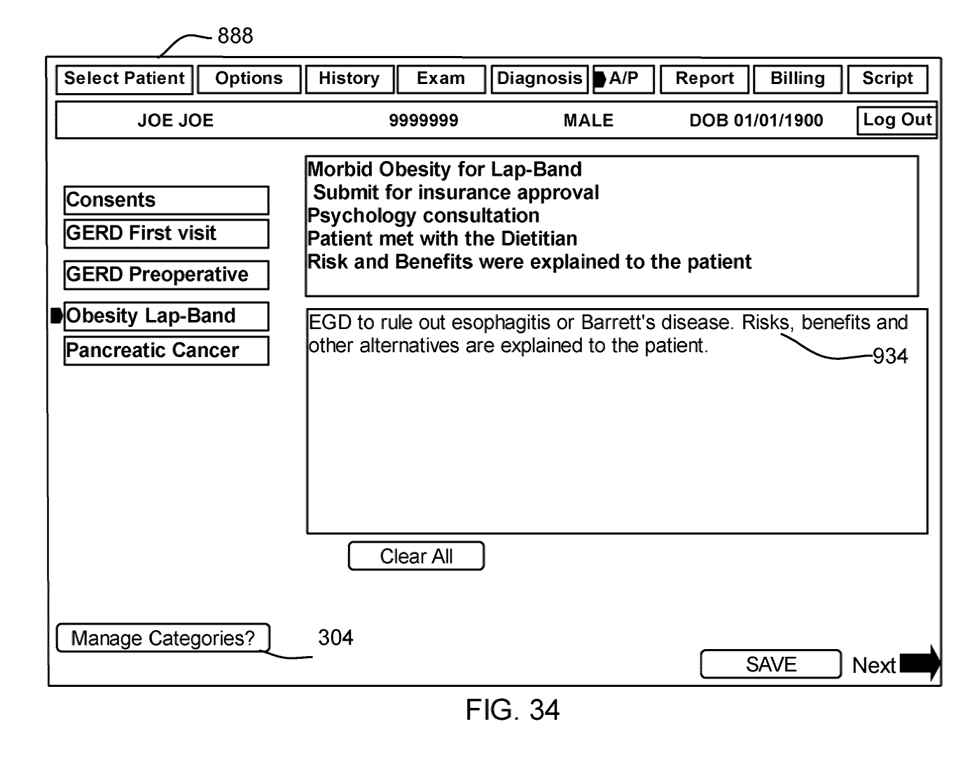

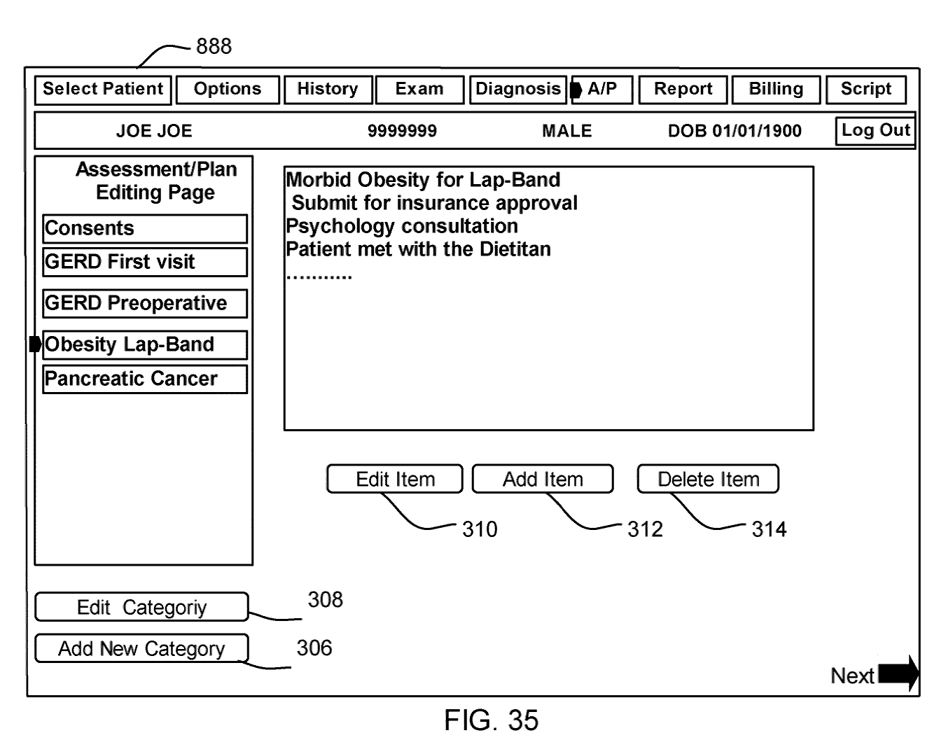

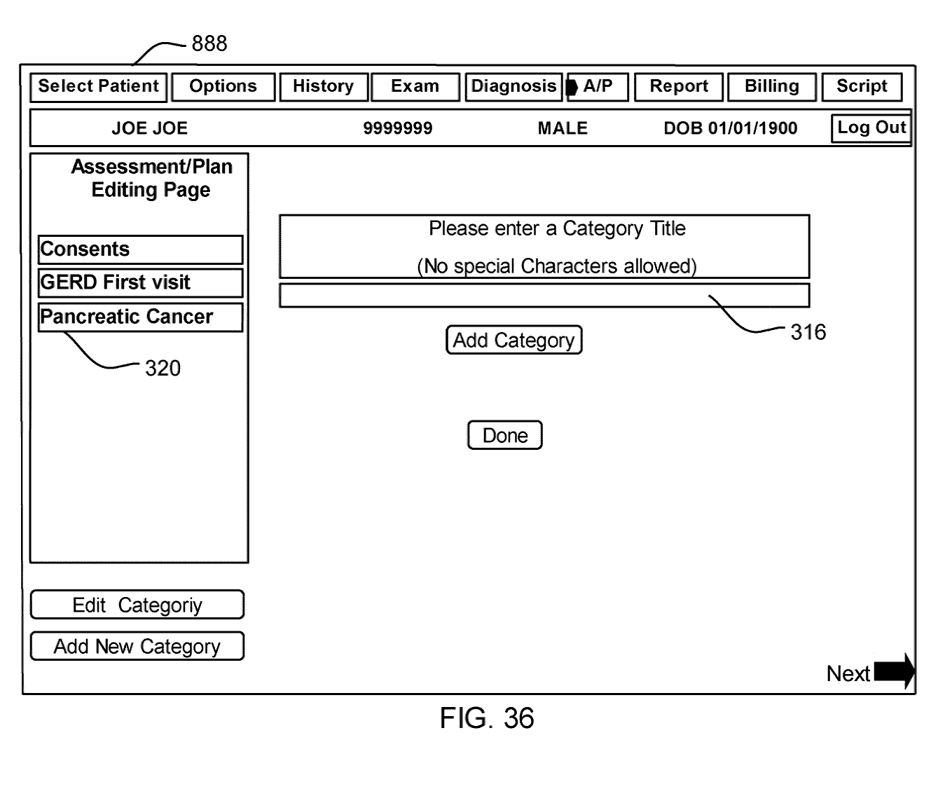

After the Diagnosis Module 882 has been completed, the user may navigate to the Assessment and Plan Module 888 using the visual screens illustrated in FIGS. 34-36. The Assessment and Plan Module 888 allows the user to create a concise summary of the patient assessment and proposed plan which the user may recommend. As illustrated in FIG. 34, the Assessment and Plan Module 888 includes custom or pre-populated plans divided into categories related to the scheduled medical event. As illustrated in FIG. 34, various plans are provided which may be assigned to the current medical event. The user may also manage the categories 304 which the plans are divided into by editing the existing category 308 or adding additional categories 306 from the Assessment and Plan Editing Page illustrated in FIG. 35. In addition, the user may add 312, edit 310 or delete 314 an item from the Assessment and Plan category. The user may also add a new category 316, as illustrated in FIG. 36, to the Assessment and Plan category list 300 from which the user may select during the Assessment and Plan Module 888.

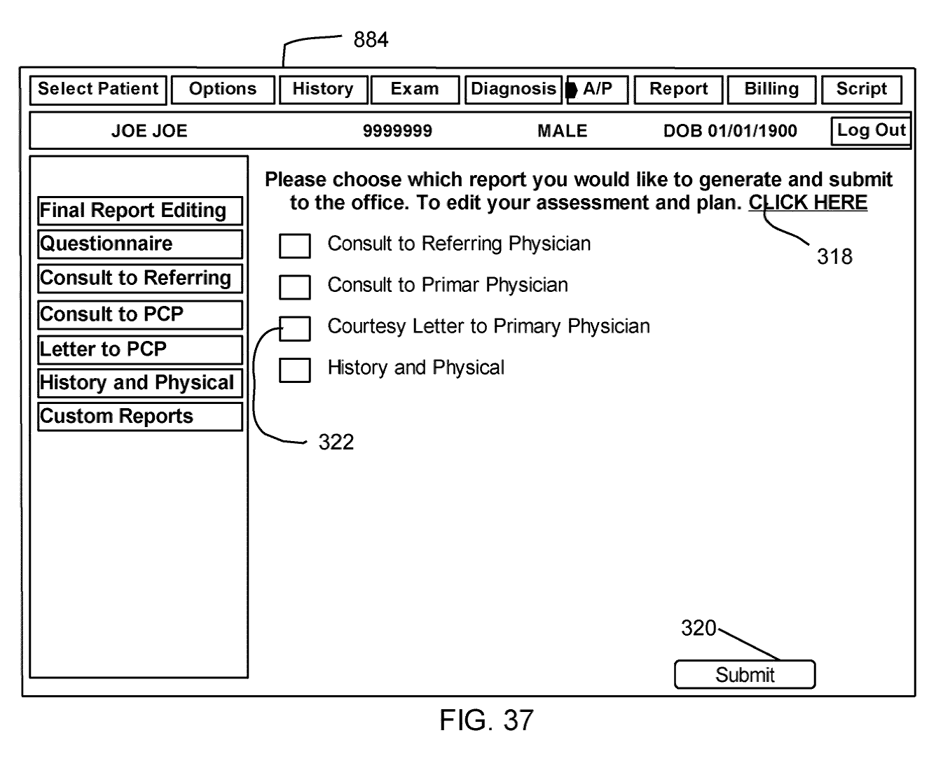

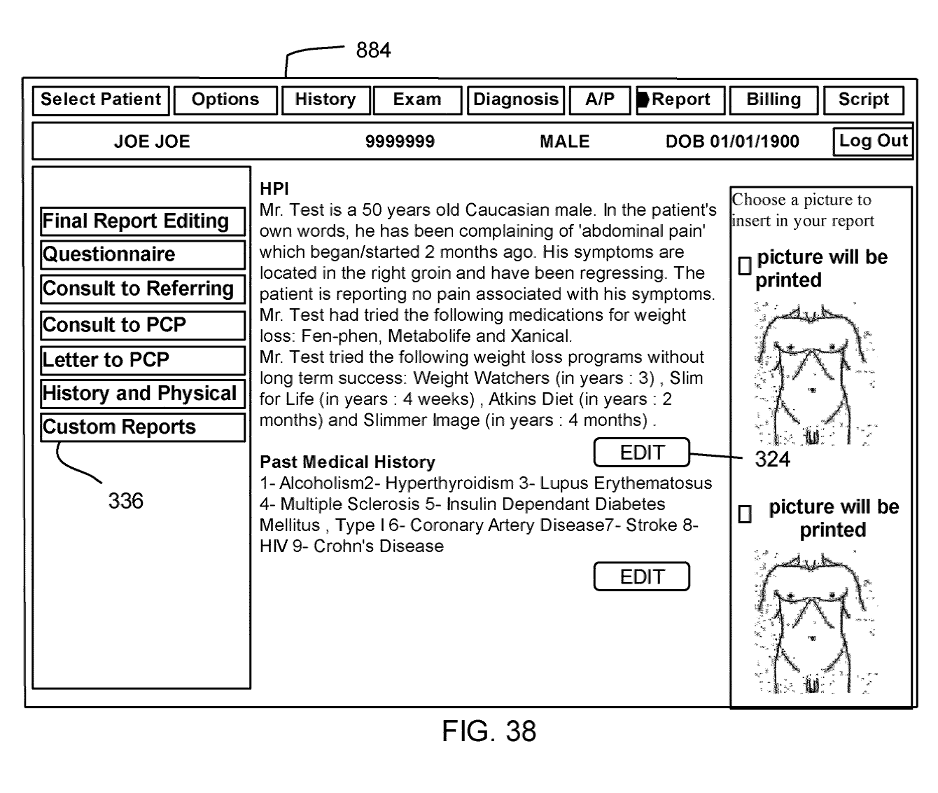

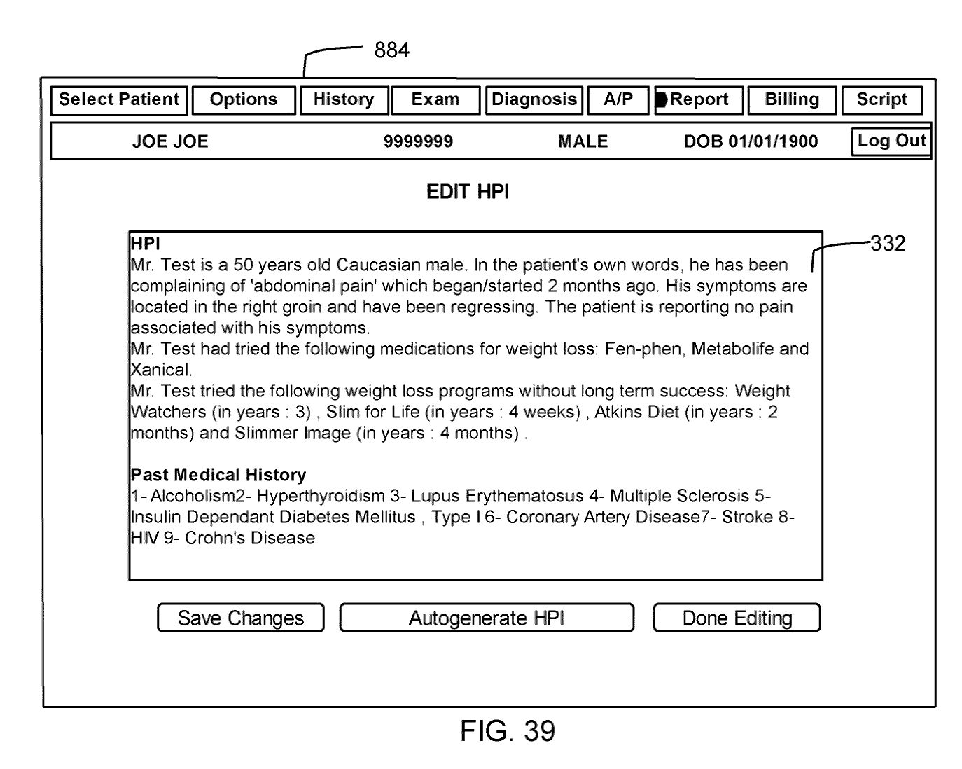

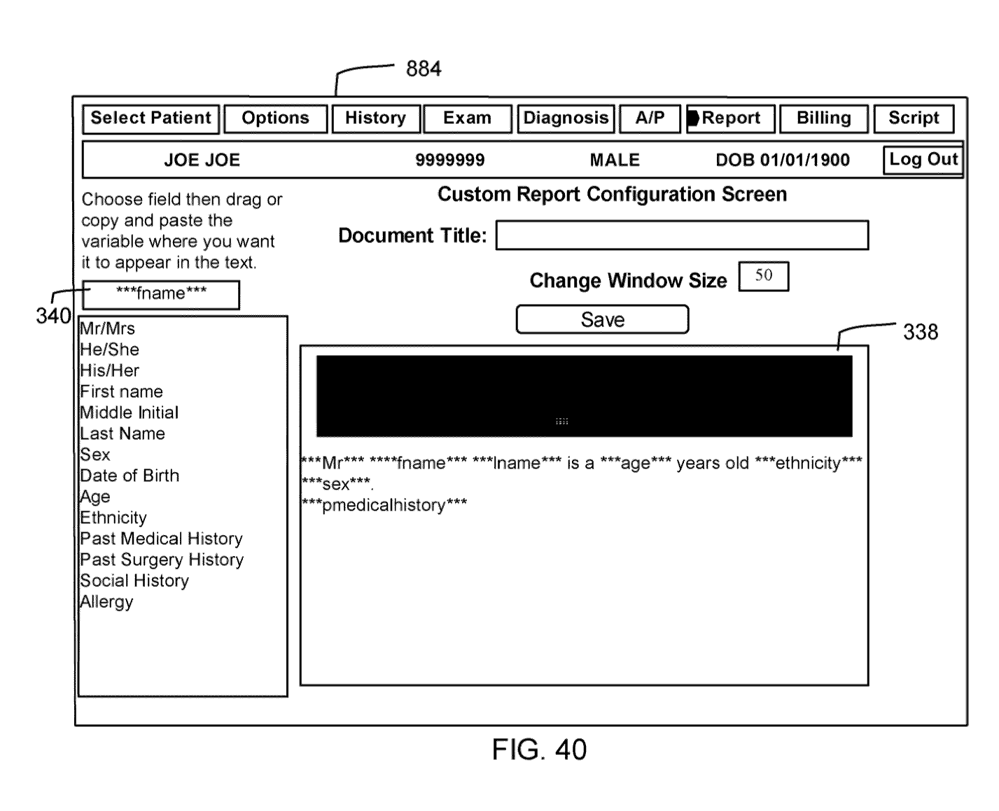

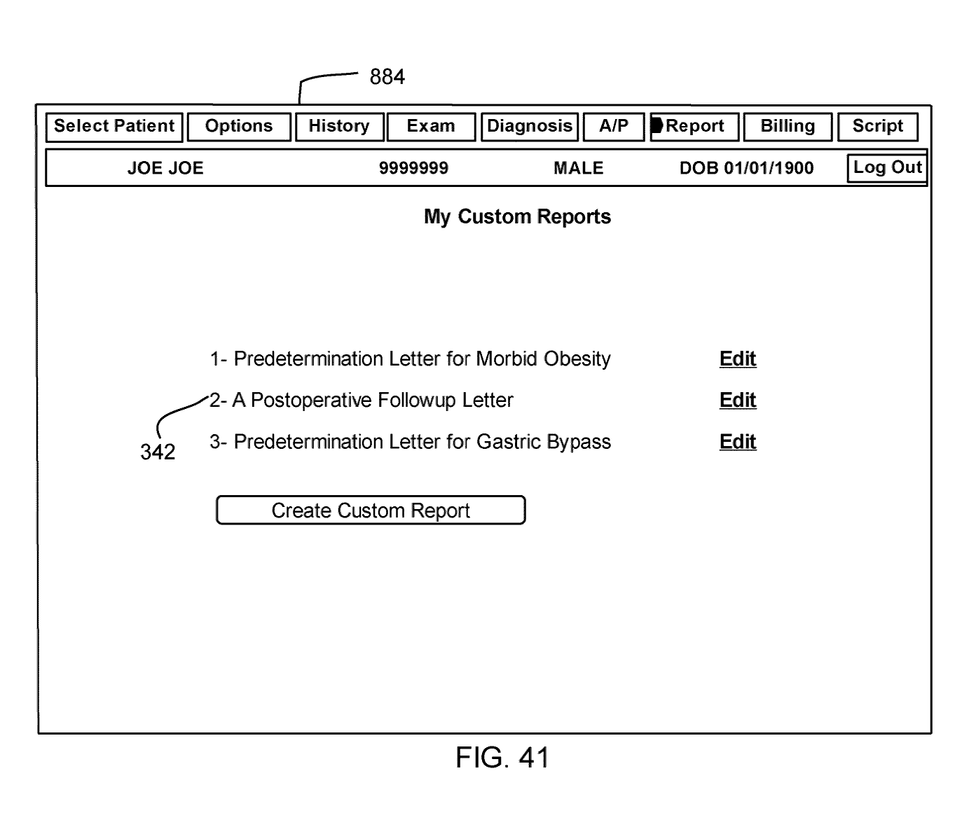

Once the user has completed recording relevant medical information and selecting the relevant assessment and plan, the user may access the Reporting Module 884 for generating standardized or custom system reports. A reporting feature is also illustrated in FIGS. 37-41, where the user may access standardized reports or the user may create his own custom report. As illustrated in FIG. 37, the user may select from a plurality of reports 322, including a consult to referring physician report, consult to the primary physician report, courtesy letter to the primary physician report, or he may generate a history and physical report. In addition, the user may create custom reports 336. Once the reports are generated 320, the system may automatically submit them to the office or allow the user to review and edit the reports 318 as necessary. FIG. 38 illustrates a sample viewing window of the Reporting Module 884 in which the user can review and edit the report 324. In addition, medical images 326 or medical literature may be selected from the system library or may be imported for selective inclusion within the report and for annotation as may be needed. These medical images 326 and/or literature may be forwarded to the primary or referring physician or they may be distributed to the patient along with any prescriptions. FIG. 39 illustrates the edit report feature 332 of the system in which the user can edit the auto generated reporting text as needed or desired by the user. The changes can be saved, or the user may discard the changes altogether and auto generate the reporting text again. Custom reports may be created using the custom reporting feature 336 illustrated in FIG. 40. Various auto fields 340 may be selected for placement within the reporting template builder 338, the auto fields being generated with linked data collected during the Questionnaire Module 878 or the Examination Module 880 with generic text located between the selected fields. The custom report also allows formatting of various text and the inclusion of images as may be necessary using standard document creation features illustrated in FIG. 40. After a custom report has been created, the user may select the custom report feature 336 from the main reporting screen illustrated in FIG. 38, with a listing of available custom reports 342 being illustrated in FIG. 41.

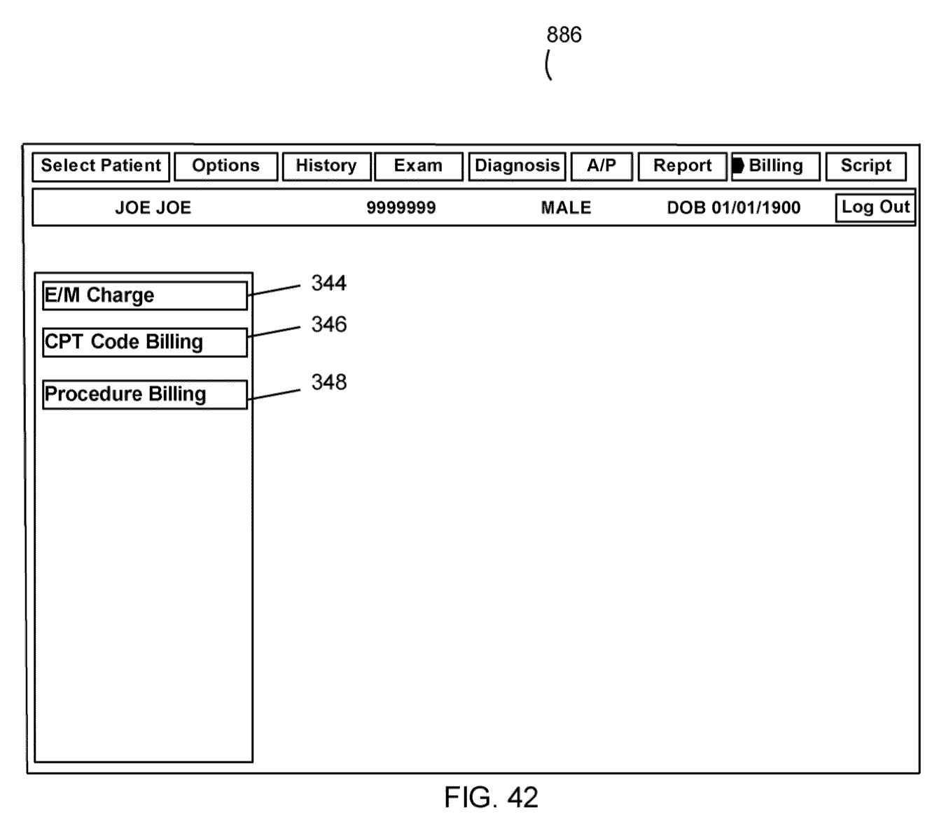

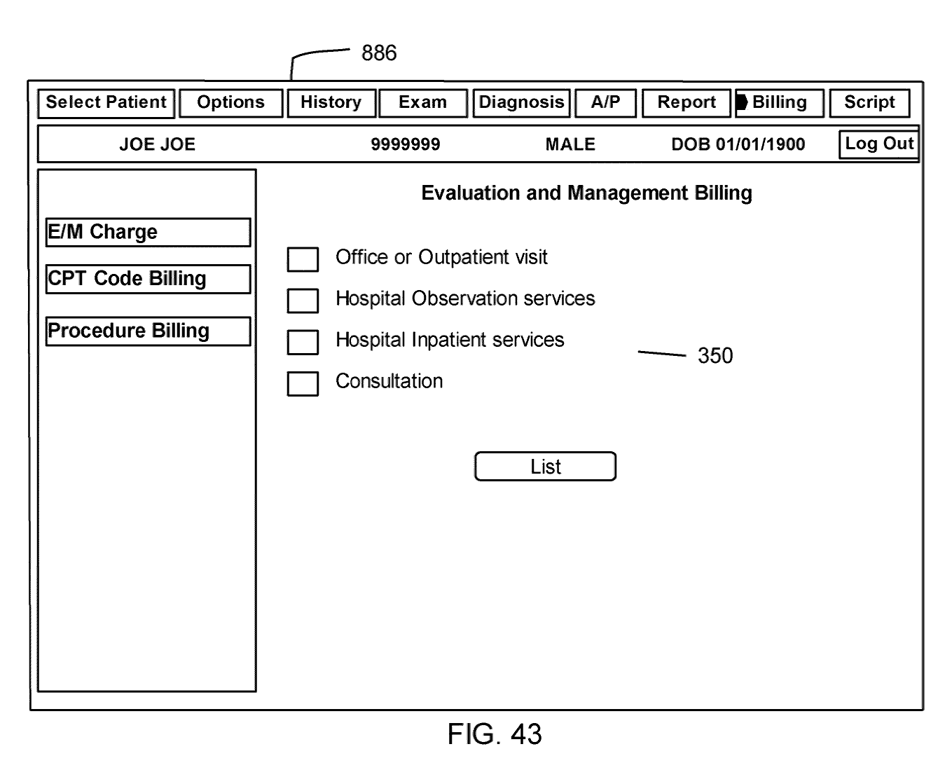

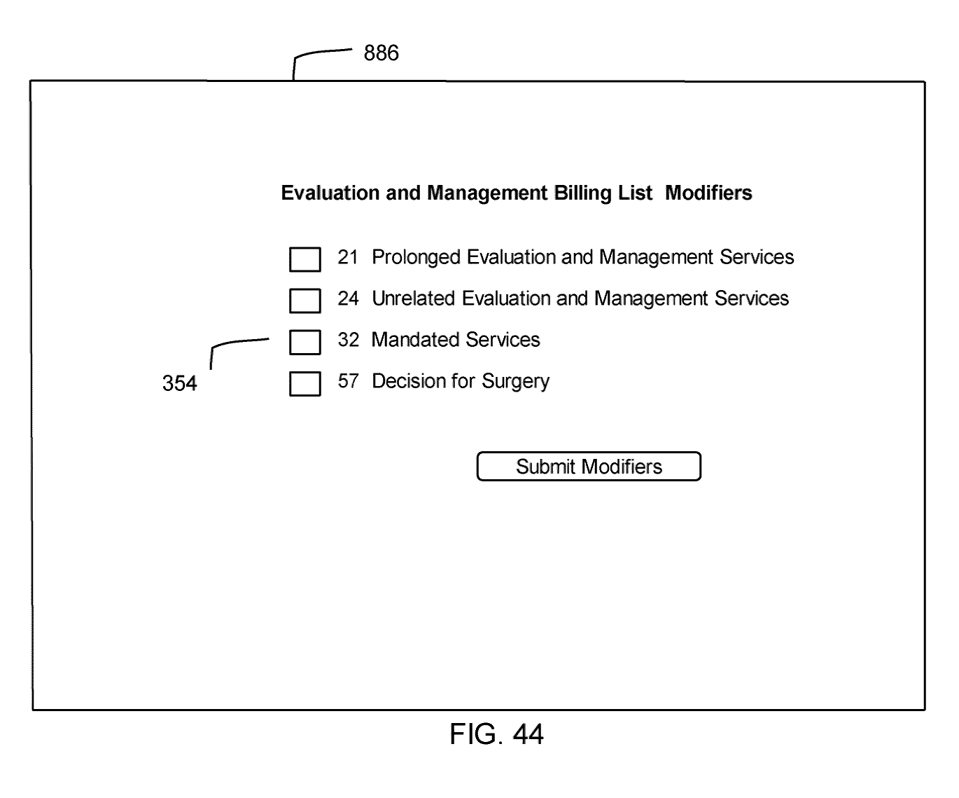

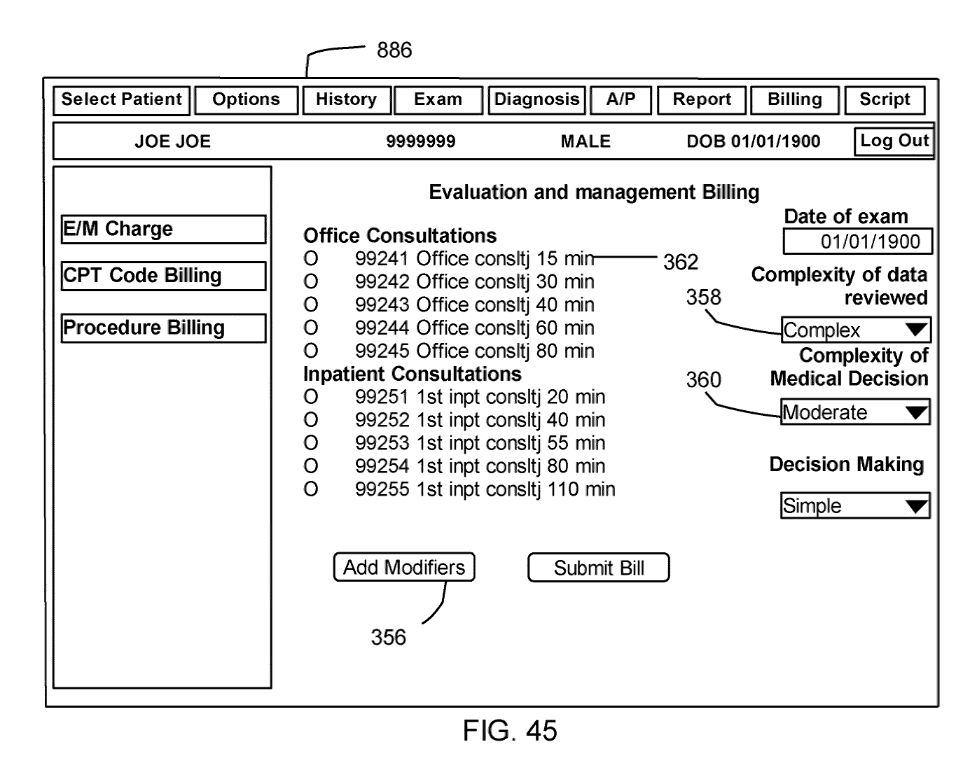

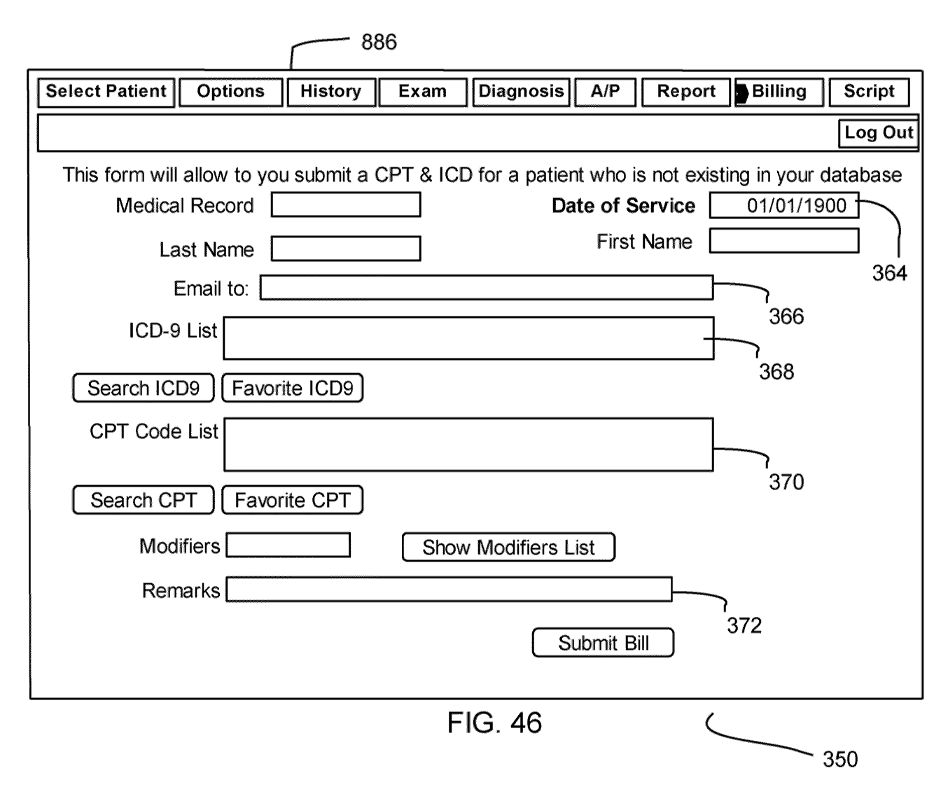

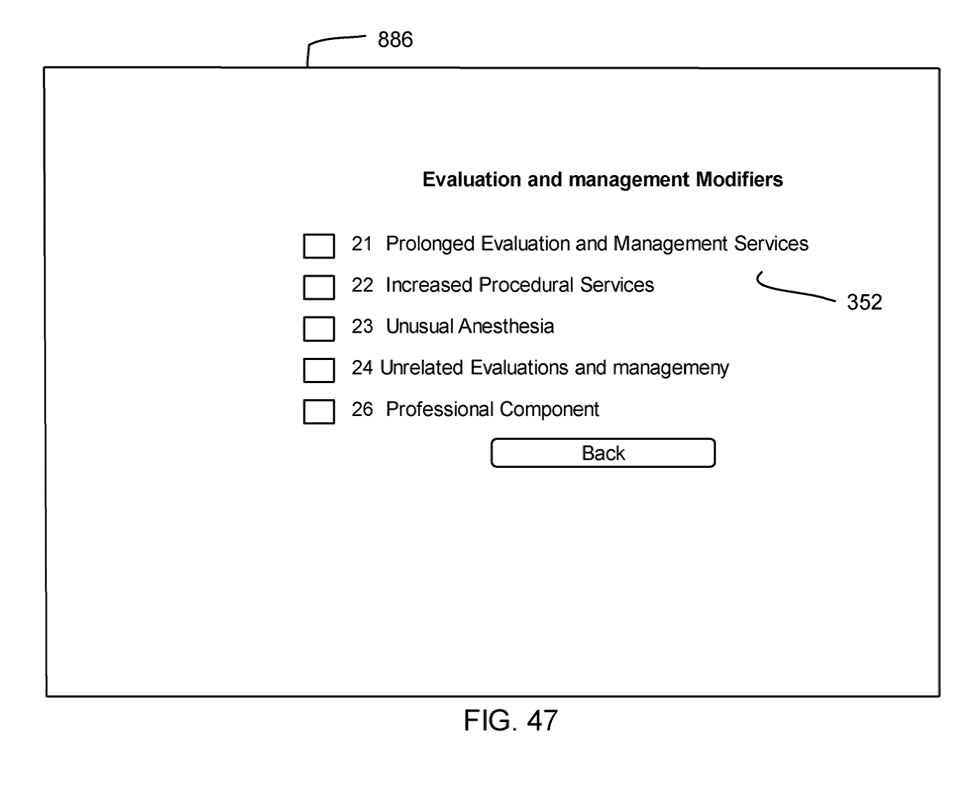

As illustrated in FIG. 42, the Billing Module 886 may also be utilized to generate relevant billing records including Evaluation and Management charges 344 and CPT codes 346, 348 as illustrated in FIG. 42. When a medical event is completed the user may utilize the system 110 to generate a bill for the completed procedure. The Evaluations and Management Billing screen is illustrated in FIG. 43 along with various Evaluation and Management modifiers in FIG. 44. As illustrated in FIGS. 43 and 44, based upon the medical event 350, various factors and modifiers 354 may be necessary to describe the medical event 350 for billing purposes. Additionally, as illustrated in FIG. 45, the system may be configured with various factors, or additional factors may be added 356 to the system 110 as needed based upon acceptable billing practices. This will allow the user to review a list of approved factors and modifiers 354, as shown in FIGS. 43 and 44, and properly select the relevant factor without having to rely upon memory or past practices. In addition, the user may select the appropriate billing code corresponding to the medical event using a simple selection screen, an example of which is illustrated in FIG. 45 including a selection of the type of consultation 362, the complexity of the information 358 and decision 360 related factors; all of which may be used to properly code a billing statement for purposes of reimbursement and/or payment to the medical office. FIG. 46 illustrates the interface screen which allows the transmittal of ICD and CPT information to a person who is not within the system database 364 but for whom an ICD or CPT code must be recorded. A text entry box is provided for receiving email address information 366 associated with the destination of the ICD 368, CPT 370 or other information 372. A listing of Evaluation and Management modifiers 352 is illustrated in FIG. 47 which may be used to record billing information and which may be associated with the patient record 140 and transmitted to the medical office for billing purposes. The CPT code listing may be submitted in short, medium or long format based upon the preferred CPT code format using a CPT lookup feature of the system 110.

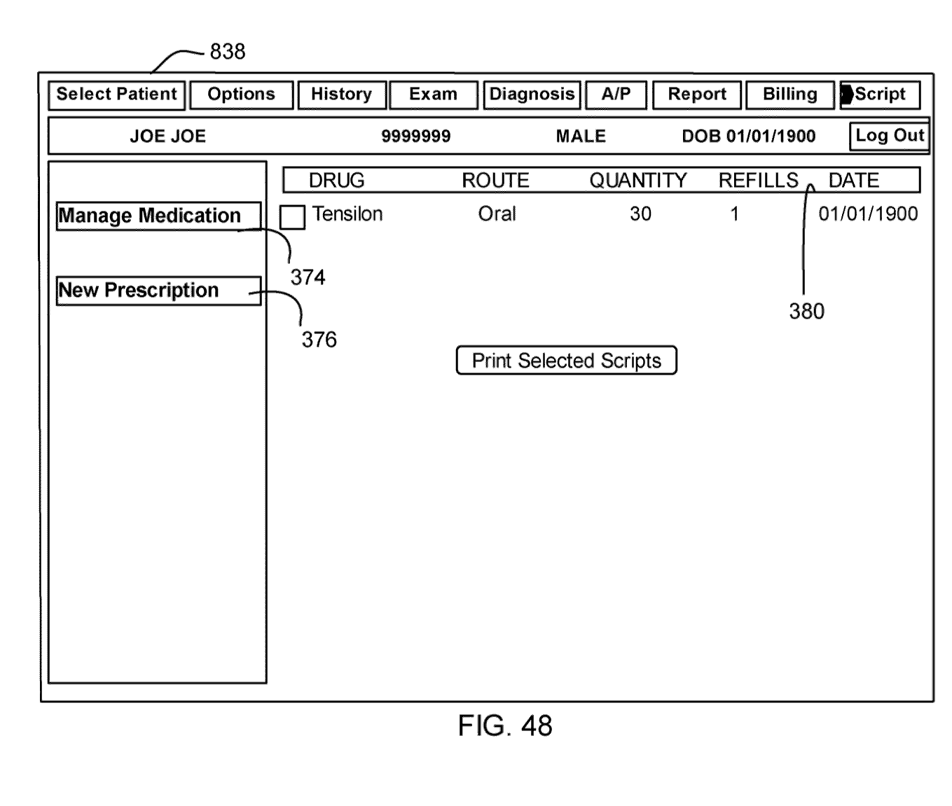

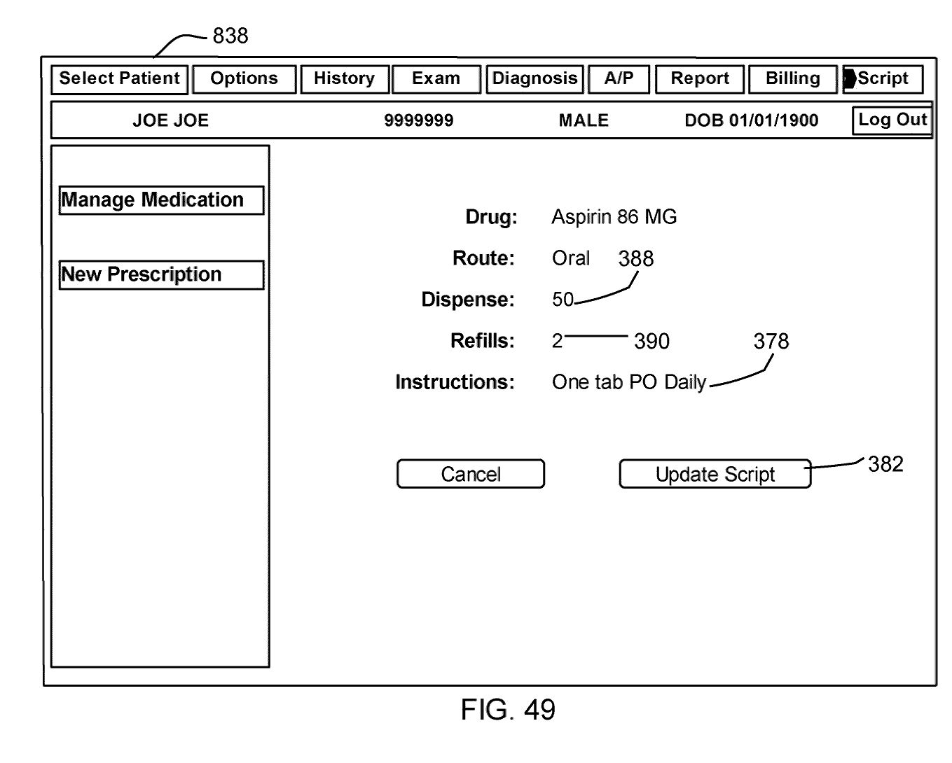

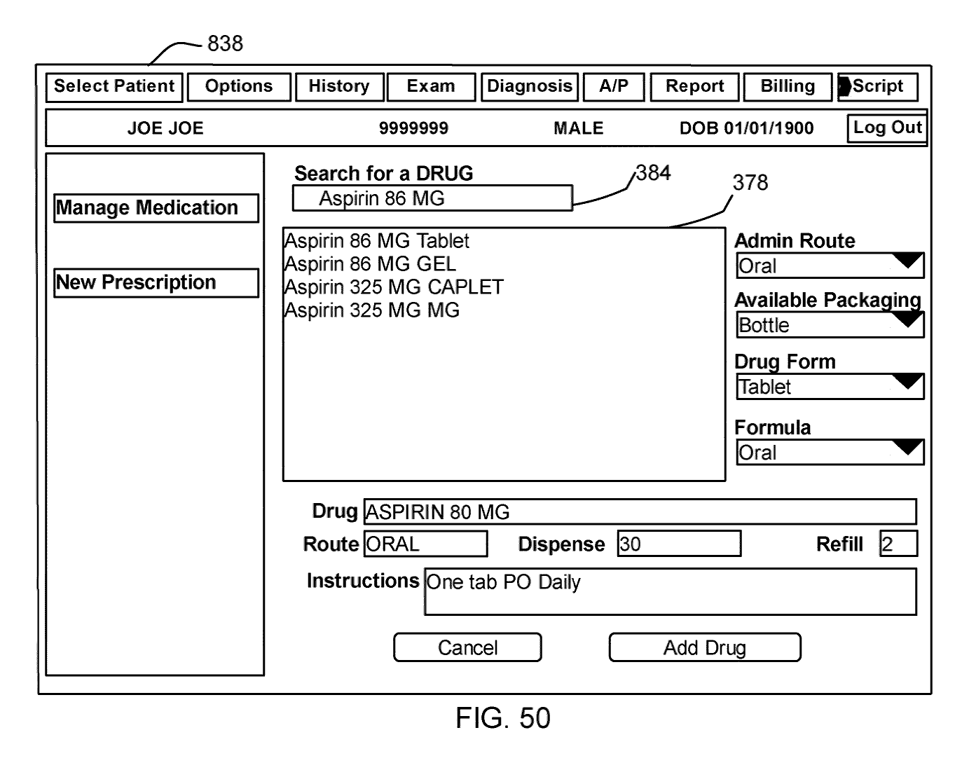

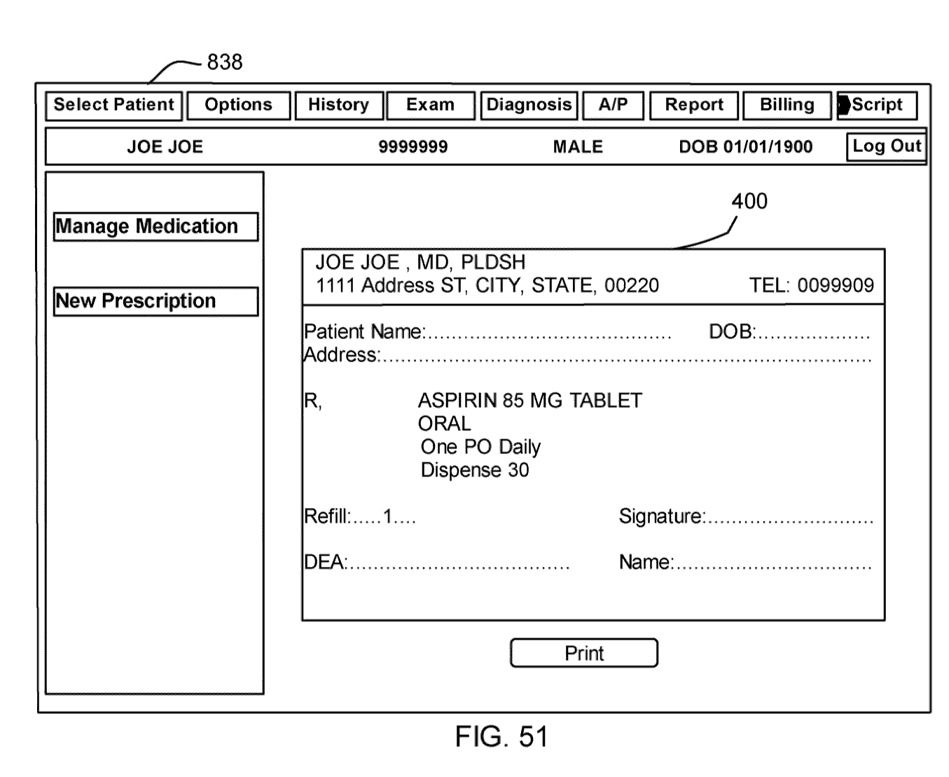

A Script Module 838 is also provided by the system 110, which allows the medical provider to manage the patient medication, generate new prescriptions or edit/update present or historical prescriptions. An example of a Script Module Overview screen is illustrated in FIG. 48 with the manage medication 374 and new prescriptions 376 features illustrated along with historical transactions 380 being displayed related to current medications. Looking at FIGS. 49 and 50, the user may search 384 for and select a medication 386 for dispensing with a prescription 400 as illustrated in FIG. 51. The user may also modify the prescription 382 in various ways including the amount to be dispensed 388, the number of refills 390 and instructions 378 associated with the prescription 400.

Throughout the system 110, various retrievably stored data is used to populate the visual screens. In this way, the system user can review, assess, analyze and treat the patient during the medical event, annotating any necessary information while the visual screens prompt the user throughout the medical event. In addition, the user may select additional reports to be created at the conclusion of the examination process or the user can select various images or medical literature to distribute to the patient.

Although webpage selection screens are generally well known, the various user interface screens may allow for various methods of data entry including, but not limited to, text fields, buttons, selection and de-selection fields, or drop down fields where the user may select the most appropriate selection from a listing of pre-populated entries.

In the Reporting Module 884, a forms repository consists of series of individual forms by standard medical payment providers retrievably stored in a database. The database can be one which supports the storage of text and binary data as MS SQL or MS Access. Preferably, a database which is accessible via Structured Query Language (SQL) is used. Medical payment providers may include federal or state government medical payment providers, such as Medicare or Medicaid. Medical payment providers may also include private medical payment providers, such as Blue Cross Blue Shield, Humana, Aetna, or Anthem.

Each form contains a set of retrievably stored rules and data requirements for a specific medical provider for at least one type of medical event. The rules associated with a form may require the medical provider to collect certain patient data. Additionally, it may require the entry of data, physician assessment data, lab data, other test and assessment data, and medical examination/procedures data. Additionally, the form may contain other static data in the form of document, images, templates, or other file types as appropriate for that medical payment provider. Where the type of medical event is a health maintenance checkup and the medical payment provider is Medicaid, the form may require the patient's contact information, the patient's Medicare identifier, and the medical provider's examination data. Where the type of medical event is a return visit from a diabetes diagnoses and the medical payment provider is a private entity, the form may require the patient's contact information, the patient's insurance identifier, the medical provider's examination data, lab test data, and that the medical provider distribute medical literature to the patient describing a medical treatment plan for the condition. Where the type of medical event is an emergency visit for a broken bone and the medical payment provider is a private insurer, the form may require the submission of an image of an x-ray of the broken bone.

Often during the daily routines of a medical office or medical provider, there is a flurry of constant activity with patients coming and going and various medical events to address each with a certain level of severity. In developing and maintaining a certain level of patient interaction, personal attention must be provided to each patient. However, in providing such personal attention, some information is invariably omitted by either the patient or the medical provider. The present invention helps to maintain uniformity during the medical event, like an examination, surgery, consultation or other, and allows the medical provider or medical office to address unanticipated situations or conditions in a predicable and expedited manner. By predicting additional areas of interest while collecting patient information, based upon preconfigured triggers, the system 110 has already facilitated the collection of additional patient information which may be of assistance during the medical event. In addition, during the medical event, rather than focusing attention on the systematic gathering of general information which has limited relevance to the scheduled medical event, the medical provider can focus on reviewing and gathering information related to the scheduled or triggered medical event.

In addition, based upon standardized healthcare industry practices, the medical provider, medical office or other administrative user spends a significant amount of time reviewing and following industry guidelines in an effort to comply with federal, state and local healthcare guidelines and complying with public and private insurance requirements for reimbursement. The amount of time spent becoming familiar with and complying with these requirements can be overwhelming and can often distract the medical provider or other medical professional from providing and delivering quality medical care. In addition, the time a medical professional spends outside of the patient room or away from the medical event is, generally, not reimbursable and may be more efficiently addressed by non-medically trained staff.

Therefore, by using the present system, the standardized practices and guidelines and administrative functionality can be addressed by the system 110 through the presentation of navigable visual screens adapted for collecting patient information. In addition, the system 110 is adapted for organizing and presenting the retrieved patient information in a logical and organized manner using the system defined navigable visual screens during the medical event. Furthermore, the system 110 allows the medical provider to temporarily deviate from the defined navigation, returning to its conclusion when desired.

The system 110 may be implemented on a computer accessible via a network. The computer may be a server, desktop, laptop, a handheld, or other known computing device. The network can be just one network, such as the Internet, a local area network, or a wide area network, or a combination of multiple networks. The patient interface might then be remote accessed on a device such as a personal computer, personal digital assistant, Smartphone, card reader, or other similar device. Alternatively, the patient interface may be accessible on a device in the medical provider's environment.

While the foregoing detailed description has disclosed several embodiments of the invention, it is to be understood that the above description is illustrative only and not limiting of the disclosed invention. It will be appreciated that the discussed embodiments and other unmentioned embodiments may be within the scope of the invention.

1. An electronic integrated medical office system for improving medical provider transactions said system comprising:
a storage device adapted for retrievable storage of patient data via a computer system having at least one processor;
a reporting and billing module in communication with said storage device for the retrieval of patient data,
a forms repository having a plurality of electronically stored standardized forms, and
said patient data being populated into at least one standardized form associated with a medical event by said reporting and billing module.

2. The system according to claim 1 wherein said forms contain a preconfigured set of rules.

3. The system according to claim 2 wherein said rules are associated with a medical event.

4. The system according to claim 1 wherein said forms contain a preconfigured set of data requirements associated with a specific medical payment provider and said medical event.

5. An electronic integrated medical office system for improving medical provider transactions said system comprising:
a storage device adapted for retrievable storage of patient data via a computer system having at least one processor;
an examination module in communication with said storage device for the retrieval of patient data,
a forms repository having a plurality of electronically stored standardized forms, and
said patient data being populated into at least one standardized form associated with a medical event by said examination module.

6. The system according to claim 5 further comprising a medical image library containing a plurality of medical condition images with at least one associated with a medical condition.

7. The system according to claim 6 wherein said stored medical condition image is annotated.

8. The system according to claim 5 further comprising a diagnosis module.

9. The system according to claim 5 further comprising a script module.

10. The system according to claim 5 further comprising an assessment and plan module.

11. The system according to claim 5 further comprising a recording device in association with said examination module for the recording of patient information.

12. The system according to claim 5 further comprising a recording device for recording patient images associated with a medical condition for retrievable storage of said medical condition images in association with said patient information.

13. The system according to claim 5 further comprising a medical literature library stored within a database on said computer system, said medical literature indexed according to a medical classification system.

14. An electronic integrated medical office system having a plurality of medical information screens for improving medical provider transactions said system comprising:
a storage device adapted for retrievable storage of patient data via a computer system having at least one processor;
a forms repository having a plurality of electronically stored standardized forms containing a preconfigured set of rules associated with a medical event, and
a questionnaire module adapted for receiving patient data using a plurality of screens generated by said processor of said computer system.

15. The system of claim 14 further comprising:
a target medical condition associated with medical information screens; and
said computer system generating the medical information screens in response to the presence of said target medical condition.
